(19) United States
(12) Patent Application Publication
(10) Pub. No.: US 2008/0145026 A1
(43) Pub. Date: Jun. 19, 2008

(54) Portable Recording Medium, Recording Medium Playback Aapparatus, and Recording Medium Playback Method

(76) Inventors: Masaaki Shimada, Tokyo (JP); Tomoaki Ryu, Tokyo (JP); Kazuhiko Nakane, Tokyo (JP)

Correspondence Address: BIRCH STEWART KOLASCH & BIRCH, PO BOX 747, FALLS CHURCH, VA, 22040-0747, US

(21) Appl. No.: 11/792,144

(22) PCT Filed: Jun. 21, 2005
(86) PCT No.: PCT/JP05/11355

§ 371 Date: Jun. 1, 2007

(51) Int. Cl. H04N 5/91

(52) U.S. Cl. 386/95

(57) ABSTRACT

A disk contains content data information 221 and content index information 220A; the content data information 221 including a plurality of programs; the content index information 220A including a flag 300 indicating presence or absence and type of non-sequential playback of the programs in the content data information 221, information 301 on number of repeats of the programs during the non-sequential playback, and a program selection condition information table 302A; wherein the program selection condition information table 302A includes playback permission/prohibition information indicating whether or not each of the programs is permitted to be reproduced during the non-sequential playback in accordance with user-definable program selection condition information held by a recording medium playback apparatus.

### TECHNICAL FIELD

The present invention relates to a portable recording medium such as various kinds of DVDs including DVD-R (Digital Versatile Disk Recordable) and DVD-RW (Digital Versatile Disk Rewritable) or semiconductor memories, a recording medium playback apparatus and a recording medium playback method capable of non-sequentially selecting and reproducing a plurality of programs recorded on this portable recording medium.

### BACKGROUND ART

One of the methods of reproducing a portable recording medium (disk) having digital data recorded thereon such as DVDs and CDs is sequential playback of sequentially reproducing programs in a specified order based on the content index information held in a disk. However, when the programs in the disk are always reproduced in the same order, the user (viewer) can expect the next program contents and hence is soon bored with playback contents. Thus, generally, the recording medium playback apparatus has not only the function of sequential playback but also the function of non-sequential playback (for example, a random playback) of changing the order of playback of the programs or the function of repeat playback (for example, see Patent Document 1). The function of the random playback is a function of generating random numbers in the recording medium playback apparatus and of automatically selecting and reproducing a program corresponding to the random number. Moreover, there is also a random playback mode of holding a usage of contents such as the number of playbacks and recording time performed in the past by the user and of selecting the programs at the occurrence frequencies depending on the usage (for example, see Patent Document 2). In the following description, “program” includes “images” of moving images and “voices” and “subtitles” synchronously related to the moving images, if necessary. Moreover, the “images” include “frames” of a plurality of still images. Furthermore, the “program” may be a program that does not include “images” but includes only “voices”.

Patent Document 1: WO97/07509 (pages 10 to 11, FIG. 7B)

Patent Document 2: Japanese Patent Application Kokai (Laid-Open) Publication No. 2001-229652 (page 6, FIG. 1)

### DISCLOSURE OF THE INVENTION

### Problems to be Solved by the Invention

When a program held by a portable recording medium is reproduced, there are time zones and regions that can effectively appeal to the users to view the program. For example, a playback in the “KYUSHU” region of a program being broadcast only in the “KANTO” region, a playback in the daytime of a late-night program for adults, and a playback after the expiration date of a program having the expiration date produce small advertising effects and provide users with unnecessary information. Therefore, these are not preferable for both of the content suppliers and the users.

For example, when a disk containing a TV program produced for a local region is distributed for users around the country, it is necessary to divide the capacity of one disk by the number of regions and to hold programs for the respective regions. Some of the programs can be shared by a plurality of regions but the sharing of data is difficult for performing random playback, so a plurality of pieces of the same program data need to be held for the respective regions. For this reason, there is a problem that a recording time for one program is compelled to be decreased. Moreover, this problem can be solved by producing respective disks in the respective regions, which in turn raises another problem that the production cost of the disks is increased and that a reduction in cost of the disk by scale merit cannot be expected. Moreover, the channel of distribution and sales needs to be divided into regions for management, so that the management of distribution and sales is expected to become complicated.

Moreover, when programs having expiration dates such as event information and advertisement information are reproduced after the expiration dates, the programs potentially provide the users with false information and could cause unnecessary confusion among the users.

Furthermore, for example, when programs recorded on the portable medium are commercial (CM) information, it is important to a content supplier that when the programs are reproduced a predetermined number of times by the recording medium playback apparatus, it is guaranteed that the numbers of playbacks of the respective programs surely becomes the predetermined numbers of times. However, there has never been known a portable recording medium capable of reproducing programs non-sequentially (for example, in the random playback mode) and surely guaranteeing the predetermined number of playbacks.

Thus, the present invention has been made to solve the above-mentioned problems in the conventional art. An object of the present invention is to provide a portable recording medium that can extracts some programs from a plurality of programs recorded on the portable recording medium in accordance with program selection condition information and non-sequentially selects and reproduces a program from the extracted programs, and a recording medium playback apparatus and a recording medium playback method capable of reproducing this portable recording medium.

Moreover, another object of the present invention is to provide a portable recording medium that enables a program not to be reproduced after the expiration date of playback of content index information recorded on the portable recording medium, and a recording medium playback apparatus and a recording medium playback method capable of reproducing this portable recording medium.

Furthermore, still another object of the present invention is to provide a portable recording medium in which when a program recorded on the portable recording medium is reproduced a predetermined number of times by a recording medium playback apparatus, the program can be reproduced non-sequentially in such a way that the number of playbacks in accordance with occurrence frequency parameter information recorded on the portable recording medium is surely guaranteed, and a recording medium playback apparatus and a recording medium playback method capable of reproducing this portable recording medium.

### Means of Solving the Problems

According to an aspect of the present invention, a portable recording medium contains coded compressed content data information; and content index information; the content data information including a plurality of programs, each of the programs being treated as a unit of playback; the content index information including a flag indicating presence or absence and type of non-sequential playback of the programs in the content data information, information on number of repeats of the programs during the non-sequential playback, and a program selection condition information table. The program selection condition information table includes playback permission/prohibition information indicating whether or not each of the programs is permitted to be reproduced during the non-sequential playback in accordance with user-definable program selection condition information held by a recording medium playback apparatus.

According to another aspect of the present invention, a portable recording medium contains coded compressed content data information; content index information; and menu screen content data information; the content data information including a plurality of programs, each of the programs being treated as a unit of playback; the content index information including a flag indicating presence or absence and type of non-sequential playback of the programs in the content data information, information on number of repeats of the programs during the non-sequential playback, and a program selection condition information table. The menu screen content data information includes menu screen information which makes it possible to select an effective item of program selection condition information from the program selection condition information table by use of a menu screen. The program selection condition information table includes playback permission/prohibition information indicating whether or not each of the programs is permitted to be reproduced during the non-sequential playback in accordance with user-definable program selection condition information assigned to a button displayed based on the menu screen information during the non-sequential playback.

According to a further aspect of the present invention, a portable recording medium contains coded compressed content data information; and content index information; the content data information including a plurality of programs, each of the programs being treated as a unit of playback; the content index information including a flag indicating presence or absence and type of non-sequential playback of the programs in the content data information, information on number of repeats of the programs during the non-sequential playback, and an expiration date information table. The expiration date information table includes viewing valid period information of each of the programs.

According to a yet further aspect of the present invention, a portable recording medium containing coded compressed content data information; and content index information; the content data information including a plurality of programs, each of the programs being treated as a unit of playback; the content index information including a flag indicating presence or absence and type of non-sequential playback of the programs in the content data information, information on number of repeats of the programs during the non-sequential playback, and a program selection condition information table; the program selection condition information table including occurrence frequency parameter information of each of the programs during the non-sequential playback. The non-sequential playback includes a pseudo-random playback guaranteeing number of playbacks, in which when the programs are reproduced a predetermined number of times by a recording medium playback apparatus, the programs are reproduced non-sequentially in such a way that number of playbacks based on the occurrence frequency parameter information is guaranteed.

### EFFECTS OF THE INVENTION

According to the present invention, the recording medium playback apparatus can extract a plurality of programs from the portable recording medium in accordance with the program selection condition information table recorded on the portable recording medium and can non-sequentially reproduce the extracted program. For this reason, according to the present invention, it is possible to divide content data into categories and to share data in the portable recording medium, and hence to dramatically enhance the rate of use of data in the portable recording medium.

Moreover, when the portable recording medium includes menu screen content data information in the present invention, the user can set the program selection condition information in the recording medium playback apparatus by the simple operation of selecting a button displayed on the screen while viewing an image. Thus, the present invention can produce an effect of facilitating the user's setting operation.

Further, if the portable recording medium includes the expiration date information table in the present invention, when a program having an expiration date is reproduced non-sequentially, the program after the expiration date is not extracted. Thus, the present invention can produce an effect of preventing the user from being supplied with false information.

Furthermore, when the portable recording medium includes occurrence frequency parameter information in the present invention, the present invention can produce such an effect that the supplier of the portable recording medium can freely and simply set the occurrence rates of programs that the supplier wants to urge the users to view.

### BRIEF DESCRIPTION OF THE DRAWINGS

FIG. 1 is a block diagram schematically showing a configuration of a recording medium playback apparatus in the first, second, and fifth embodiments;

FIG. 2 is a diagram showing an example of an internal data structure of a DVD-ROM disk in the first, second, third, fourth, sixth, and seventh embodiments;

FIG. 3 is a diagram showing an internal structure of a playback block of the DVD-ROM disk in the first embodiment;

FIG. 4 is a flowchart showing processing of reproducing the DVD-ROM disk in the first, second, third, and fourth embodiments;

FIG. 5 is a flowchart showing processing by which the recording medium playback apparatus in the first embodiment extracts a program supposed to be reproduced non-sequentially;

FIG. 6 is a diagram showing an algorithm structure of extracting a program from the DVD-ROM disk in the first embodiment;

FIG. 7 is a diagram showing an internal structure of a playback block of the DVD-ROM disk in the second embodiment;

FIG. 8 is a flowchart showing processing by which the recording medium playback apparatus in the second embodiment extracts a program supposed to be reproduced non-sequentially;

FIG. 9 is a diagram showing an algorithm structure of extracting a program from the DVD-ROM disk during a random playback in the second embodiment;

FIG. 10 is a block diagram schematically showing a configuration of a recording medium playback apparatus in the third and fourth embodiments;

FIG. 11 is a diagram showing an internal structure of a playback block of the DVD-ROM disk in the third embodiment;

FIG. 12 is a flowchart showing processing by which the recording medium playback apparatus in the third embodiment extracts a program supposed to be reproduced non-sequentially;

FIG. 13 is a diagram showing an algorithm structure of extracting a program from the DVD-ROM disk in the third embodiment;

FIG. 14 is a diagram showing an internal structure of a playback block of the DVD-ROM disk in the fourth embodiment;

FIG. 15 is a flowchart showing processing by which the recording medium playback apparatus in the fourth embodiment extracts a program supposed to be reproduced non-sequentially;

FIG. 16 is a diagram showing an algorithm structure of extracting a program from the DVD-ROM disk in the fourth embodiment;

FIG. 17 is a diagram showing an example of an internal data structure of a DVD-ROM disk in the fifth embodiment;

FIG. 18 is a diagram showing a menu screen in the fifth embodiment;

FIG. 19 is a diagram showing an example of an internal data structure of sub-image data information in the fifth embodiment;

FIG. 20 is a flowchart showing processing of setting region selection condition information in the fifth embodiment;

FIG. 21 is a block diagram schematically showing a configuration of a recording medium playback apparatus in the sixth and seventh embodiments;

FIG. 22 is a flowchart showing operation of pseudo-random playback guaranteeing number of playbacks in the sixth embodiment when the selection probability is constant;

FIG. 23 is a diagram showing pseudo-random playback guaranteeing number of playbacks in the sixth embodiment when the selection probability is constant;

FIG. 24 is a flowchart showing operation of pseudo-random playback guaranteeing number of playbacks in the seventh embodiment when the selection probability is changed; and

FIG. 25 is a diagram showing pseudo-random playback guaranteeing number of playbacks in the seventh embodiment when the selection probability is changed.

### DESCRIPTION OF THE REFERENCE NUMERALS

100A, 100B, 100C, 100D, 100E, 100F, 100G DVD-ROM disk (portable recording medium); 101, . . . , 106 recording medium playback apparatus; 110 playback drive; 111 program playback section; 112 system controller; 113 user operation section; 114 region selection information storage; 115 program extractor; 116 random number generator; 117 time information acquisition section; 118 number-of-playbacks recording section; 119 non-volatile memory; 120 display section; 201 disk inner peripheral side; 202 disk outer peripheral side; 210 lead-in zone; 211 file management information zone; 212 data zone; 213 lead-out zone; 200, 220A, 220B, 220C, 220D content index information; 221 content data information; 230 playback block; 250 menu screen content data information; 251 image pack; 252 voice pack; 253 sub-image pack; 300 non-sequential playback type flag; 301 non-sequential playback repeat number information; 302A, 302B, 302D program selection information table; 303 program (PG); 304A, 304B, 304D program selection condition field; 310c, 310D expiration date information table; 901 menu screen; 902 image data information; 903 sub-image data information; 911 region information selection button of the “TOHOKU” region; 912 region information selection button of the “KANTO” region; 913 region information selection button of the “KANSAI” region; 914 region information selection button of the “CHUGOKU” region; 915 region information selection button of the “KYUSHU” region; 916 button for starting to reproduce a target program; 1000 sub-image data information; 1001 graphic control data; 1002 graphic image data; 1011 button information; 1012 button data; 1021 button position information; 1022 adjacent button information; 1023 button command; 1031 command type; 1032 command argument; 1033 region selection information number.

### BEST MODE FOR CARRYING OUT THE INVENTION

In the first place, preconditions in the first to seventh embodiments of the present invention to be described below will be described specifically. In the following description will be described a case in which a portable recording medium is a DVD-ROM (Digital Versatile Disk Read Only Memory) disk. Moreover, in the following description will be described a case in which a MPEG-2 compressed commercial program (CM) is recorded on the DVD-ROM disk. However, a portable recording medium to which the present invention can be applied is not limited to the above-mentioned disk but includes various kinds of recording media like semiconductor memories such as a DVD-RAM (Digital Versatile Disk Random Access Memory), DVD-R and a SmartMedia (Registered Trademark). Further, programs recorded on the portable recording medium are not limited to commercial programs but may be other kinds of programs such as a music program, a movie program, and an education program.

Moreover, in the following description, regional (local) specified information will be described as a program selection condition information table recorded on the portable recording medium and user-definable program selection condition information held by a recording medium playback apparatus. However, the program selection condition information recorded on the portable recording medium and the user-definable program selection condition information held by the recording medium playback apparatus are not limited to the regional specified information. For example, the viewer's age information items, the viewer's gender information items, the playback time information items, or a combination of these information items, or a combination of these information items and other regional specified information items can also be used as program selection condition information recorded on the portable recording medium and user-definable program selection condition information held by the recording medium playback apparatus

In this regard, in this specification and claims, “non-sequential playback” is a mode of playback that is different from a mode of sequential playback for reproducing information in an order based on the content index information of the portable recording medium, and has a variety in the order of playback. Moreover, “non-sequential playback” includes “random playback”, “shuffle playback”, and “pseudo-random playback guaranteeing number of playbacks”.

### FIRST EMBODIMENT

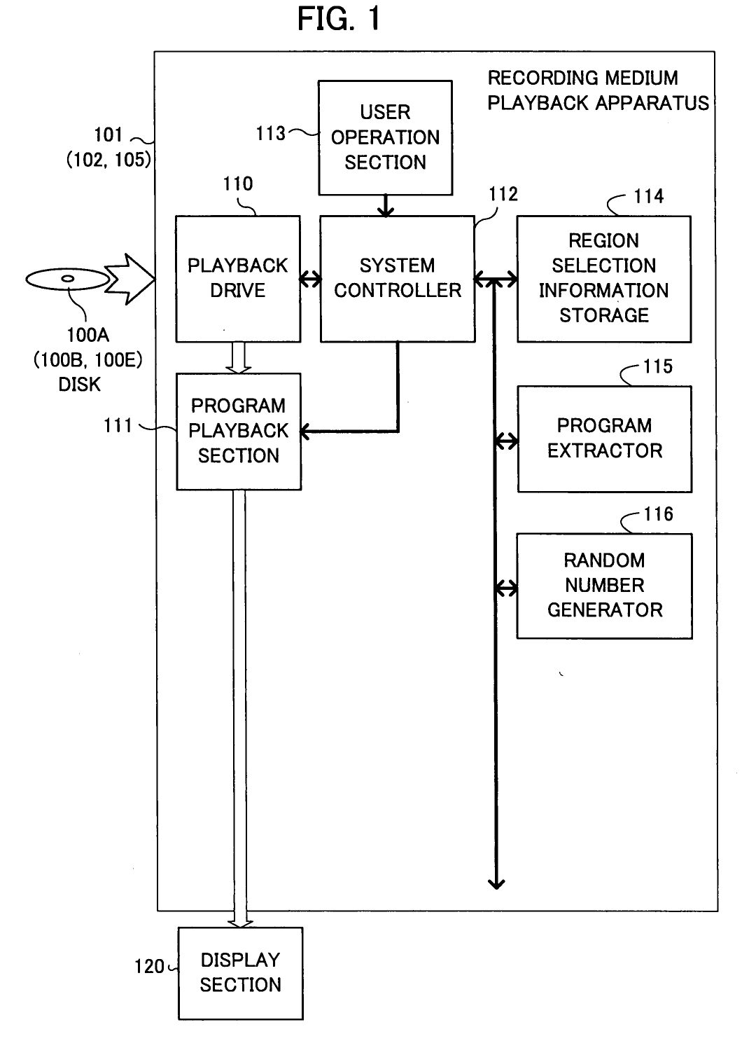

A portable recording medium 100A, a recording medium playback apparatus 101, and a recording medium playback method in the first embodiment will be described below. FIG. 1 is a block diagram schematically showing a configuration of the recording medium playback apparatus 101 in the first embodiment. As shown in FIG. 1, the recording medium playback apparatus 101 reproduces programs recorded on the DVD-ROM disk 100A as a portable recording medium. The recording medium playback apparatus 101 includes a playback drive 110 which reads information from the DVD-ROM disk 100A, a program playback section 111 which decompresses a coded compressed signal read from the DVD-ROM disk 100A to produce an analog image; a system controller 112 which controls the whole of the recording medium playback apparatus 101 in an integrated manner, and a user operation section 113 by which the user inputs data to the system controller 112. The user operation section 113 is, for example, a button input part disposed on the front panel of the recording medium playback apparatus 101 but may be a remote input unit (external remote controller) or the like. Moreover, the recording medium playback apparatus 101 includes a region selection information storage 114 which stores apparatus playback region information inputted from the user operation section 113 as user-definable program selection condition information; and a program extractor 115 which extracts a program to be selected in non-sequential playback on the basis of apparatus playback region information of the region selection information storage 114 during the non-sequential playback; and a random number generator which generates random numbers. The program extractor 115 selects a program to be reproduced next from a plurality of extracted programs in accordance with a random number generated by the random number generator 116. The program playback section 111 converts the selected program into analog image signals in accordance with a command from the system controller 112 and sends the analog image signals to a display section 120.

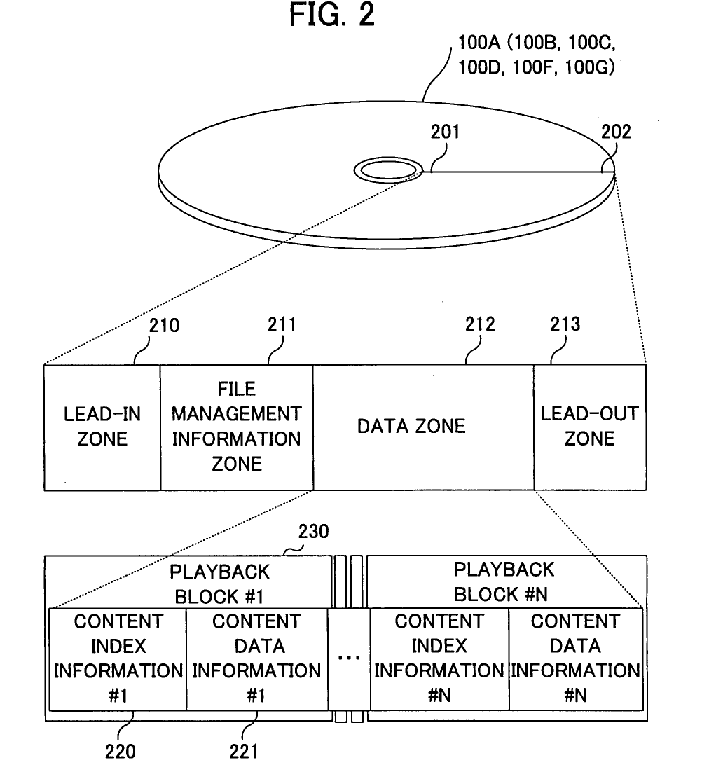

FIG. 2 is a diagram showing an example of an internal data structure of the DVD-ROM disk 100A as the portable recording medium in the first embodiment. As shown in FIG. 2, in the DVD-ROM disk 100A, data is recorded between a disk inner peripheral side 201 and a disk outer peripheral side 202. In the DVD-ROM disk 100A, a lead-in zone 210 in which the starting information and physical properties of the DVD-ROM disk 100A are written, a file management information zone 211 in which the address information of file data of the DVD-ROM disk 100A is managed, a data zone 212 in which a content supplier can previously record information, and a lead-out zone 213 in which disk terminal information is recorded are arranged in an order from the disk inner peripheral side 201 to the disk outer peripheral side 202.

Moreover, as shown in FIG. 2, the data zone 212 includes at least one playback block 230. The playback block shows a series of contents and includes two kinds of information of content index information 220 and content data information 221. The content data information 221 includes a plurality of programs, where a program is a minimum unit of playback control and hereinafter also referred to as a “PG”. Moreover, the content index information 220 includes the information of the plurality of programs stored in the content data information 221 such as the order of playback, the presence or absence and type of non-sequential playback, and the number of repeats in non-sequential playback. That is, in the content index information 220 is written a rule showing the order of playback of the programs included in the content data information 221.

FIG. 2 shows an example in which the data zone 212 includes N playback blocks 230 of a playback block #1, a playback block #2, . . . , a playback block #N. FIG. 2 shows, by way of example, a case in which the content index information 220 is described in a head portion (inner side) in each playback block 230 and in which content data information 221 is described in a tail portion (outer side) of the content index information 220, but the arrangement of the content index information 220 and the content data information 221 is not limited to the example shown in FIG. 2. The inner structure of the data zone 212 may be another structure in which, for example, the content index information 220 of all of the playback blocks 230 is described in the head portion of the data zone 212.

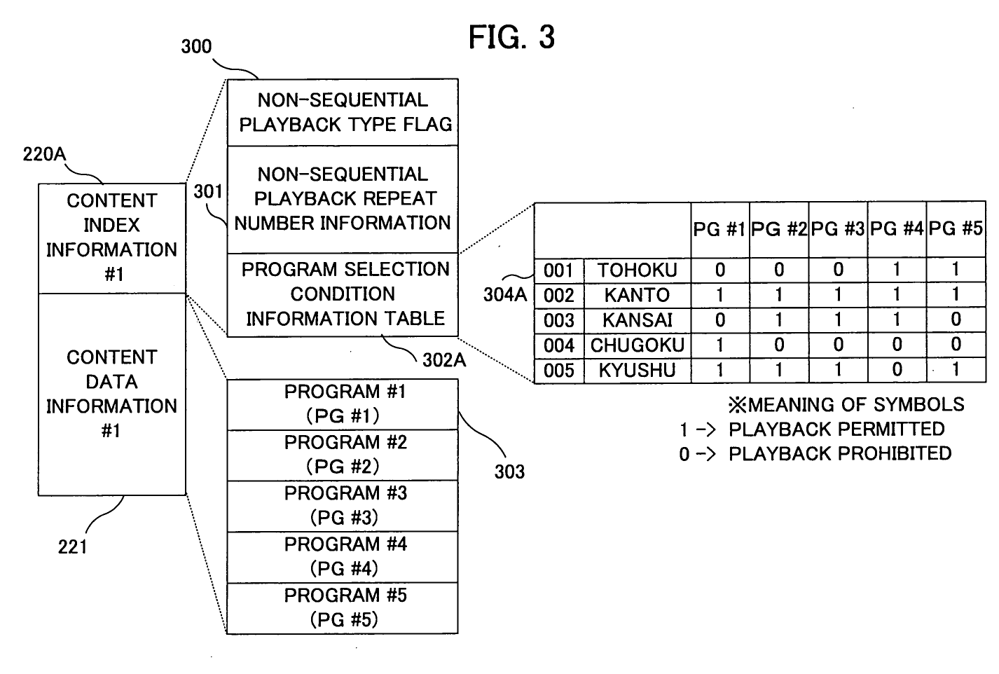

FIG. 3 is a diagram showing an example of the internal structure of the playback block 230 of the DVD-ROM disk 100A in the first embodiment. As shown in FIG. 3, the content index information 220A includes a non-sequential playback type flag 300 showing either random playback or shuffle playback during the non-sequential playback; non-sequential playback repeat number information 301, which shows how many times the non-sequential playback is performed; and a program selection condition information table 302A containing information showing whether or not programs 303 related to respective region selection information of user-defined program selection information of the recording medium playback apparatus 101 are permitted to be selected.

The program selection condition information table 302A includes one or more program selection condition fields 304A (for example, in FIG. 3, information items indicated by “001, TOHOKU, 0, 0, 0, 1, 1” constitute one field). For example, as shown in FIG. 3, the program selection condition information table 302A is a two-dimensional table information having a plurality of program selection condition fields 304A arranged in a longitudinal direction (column direction) and having a plurality of programs (for example, PG#1 to PG#5 in FIG. 3) constituting the playback block 230 arranged in a lateral direction (row direction). In the first embodiment, the plurality of program selection condition fields 304A is classified into the categories of region. Classification code information used in this program selection condition field 304A is standardized so as to record programs in a code system determined in advance by the DVD-ROM disk 100A and the recording medium playback apparatus 101. In FIG. 3 is shown an example in which the whole country is divided into five regions (for example, in FIG. 3, the “TOHOKU” region, the “KANTO” region, the “KANSAI” region, the “CHUGOKU” region, and the “KYUSHU” region) in the DVD-ROM disk 100A and in which whether or not a program is permitted to be extracted during the non-sequential playback is held as one bit information. In this regard, region management can more severely be performed by dividing the whole country into smaller units of regions.

On the other hand, the content data information 221 includes at least one program 303. The program 303 is a minimum unit by which playback can be controlled during the non-sequential playback. In the first embodiment, the content data information 221 includes five programs 303 (for example, in FIG. 3, PG#1 to PG#5). However, the number of programs included in the content data information 221 is not limited to five but may be four or less, or six or more.

In the DVD-ROM disk 100A in the first embodiment, by providing the program selection condition information table, a program depending on the user-defined program selection information (in the first embodiment, region information) defined by the user can be extracted in the recording medium playback apparatus 101 during the non-sequential playback, and non-sequential playback can be performed by use of the extracted programs.

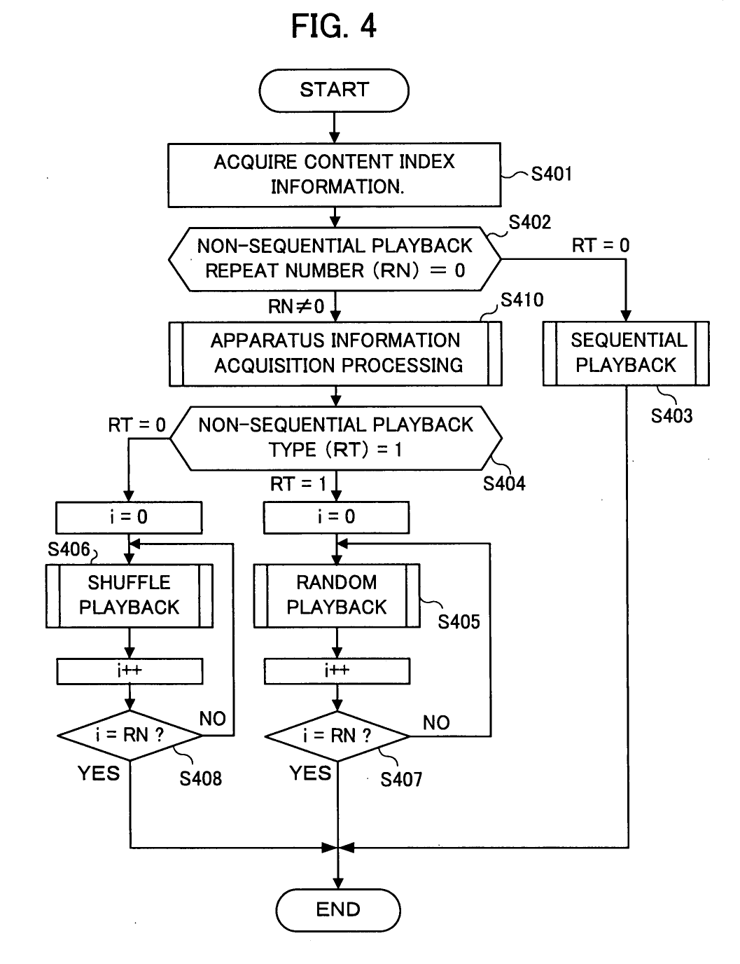

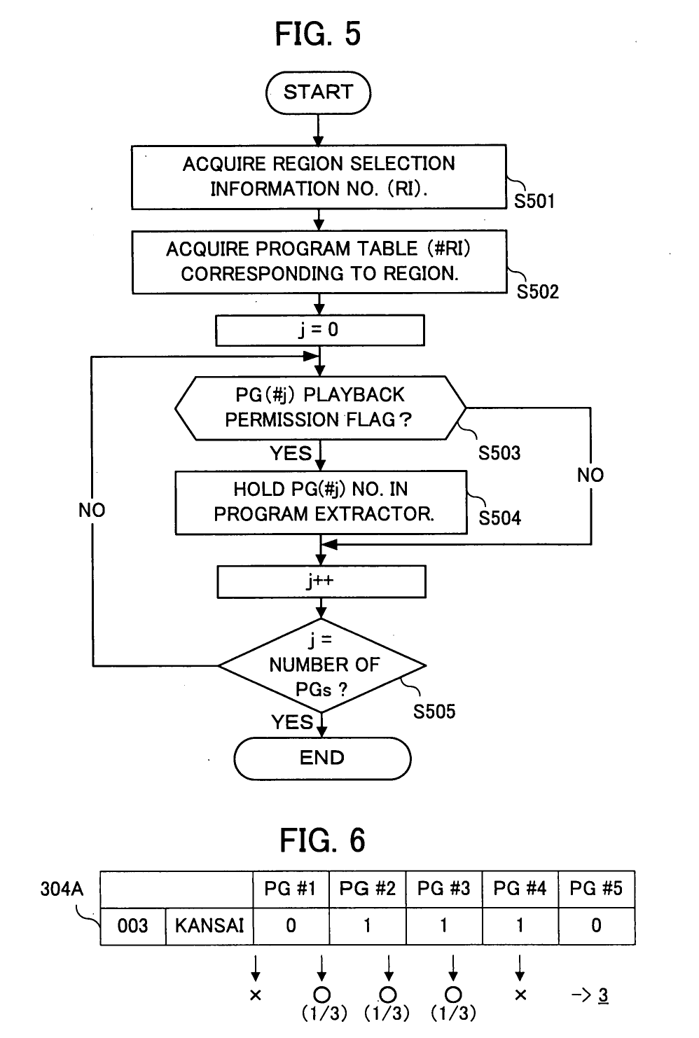

FIG. 4 is a flowchart showing the processing of reproducing the DVD-ROM disk 100A by the recording medium playback apparatus 101 in the first embodiment. Moreover, FIG. 5 is a flowchart showing processing (step S410 in FIG. 4) by which the recording medium playback apparatus 101 in the first embodiment extracts a program to be proposed for non-sequential playback. Further, FIG. 6 is a diagram showing an algorithm of extracting a program from the DVD-ROM disk 100A in the first embodiment.

An example of a playback processing operation to the playback block 230 in the first embodiment will be described by use of FIG. 1 to FIG. 6. Here will be described processing in the case of setting a non-sequential playback type flag held as content index information 220A (hereinafter also referred to as “RT (Repeat Type)”) to ‘1’ (that is, setting random playback) and setting the non-sequential playback repeat number information (hereinafter also referred to as “RN (Repeat Number)”) to 3 in the DVD-ROM disk 100A.

When the playback block 230 of the DVD-ROM disk 100A is reproduced by the recording medium playback apparatus 101, first, the content index information 220 (shown by a reference numeral 220A in FIG. 3) is read from the playback block 230 (step S401 in FIG. 4).

Next, the system controller 112 reads the non-sequential playback repeat number information 301 from the content index information 220. In the first embodiment, an information zone of seven bits is provided as the recording zone of the non-sequential playback repeat number information 301 and a value to be set (the number of repeats) ranges from 0 to 127. A conditional branch as described below is executed in accordance with a read value (step S402 in FIG. 4). When a value of 0 is set in the non-sequential playback repeat number information 301 (that is, when RN=0), the sequential playback of normal playback is performed as a mode of reproducing the playback block 230 (step S403 in FIG. 4). The sequential playback is a playback mode of reproducing the playback block 230 in an order based on the content index information 220 of the DVD-ROM disk 100A (in the first embodiment, also the order of recording the programs 303 recorded on the content data information 221, that is, the order of PG#1, PG#2, PG#3, PG#4, and PG#5). On the other hand, when a value other than zero is set in the non-sequential playback repeat number information 301 (that is, when RN≠0), the system controller 112 determines that non-sequential playback is performed, stores the non-sequential playback repeat number information 301, and advances the processing to a step of apparatus information acquisition processing (step S410 in FIG. 4).

In the step of apparatus information acquisition the system controller 112 executes processing shown in processing (step S410 in FIG. 4) in the first embodiment, the flowchart in FIG. 5. The system controller 112 acquires region selection information (user-definable program selection condition information) held in the region selection information storage 114 (step S501 in FIG. 5). As the region selection information is set a value within the range of the number of regions recorded on the program selection condition field 304A of the DVD-ROM disk 100A. For example, in FIG. 3, the program selection condition field 304A is divided into five regions, so the region selection information (hereinafter also referred to as “RI (Region Information)” takes any one of ‘001’, . . . , ‘005’. In the first embodiment will be described a case in which a value of ‘003’ (that is, the “KANSAI” region) is set as region selection information RI. In this regard, the user-definable program selection condition information such as region selection information RI may be manually inputted by a user by the use of the user operation section 113, or may be previously inputted by a manufacturer in accordance with the sales region of the recording medium playback apparatus 101, or may automatically be set to the recording medium playback apparatus 101 through a network or the like connected by the user, or may be set from a menu screen to be described in the fifth embodiment.

Next, the system controller 112 acquires the program selection condition field 304A corresponding to the value of region selection information stored in the recording medium playback apparatus 101 from the program selection condition information table 302A of the DVD-ROM disk 100A (step S502 in FIG. 5). In the first embodiment, it is assumed that the region selection information RI is ‘003’, so the system controller 112 acquires the program selection condition field 304A of the “KANSAI” region (RI=003) (that is, “003, KANSAI, 0, 1, 1, 1, 0” of the program selection condition information table 302A in FIG. 3). As shown in FIG. 3, the information is recorded by two values of 0 and 1 in the program selection condition field 304A. In the program selection condition field 304A, a value of 1 indicates that the program is a program permitted to be reproduced, and a value of 0 indicates that the program is a program prohibited from being reproduced. Next, it is determined whether or not the program in the program selection condition field 304A is permitted to be reproduced (step S503 in FIG. 5). Then, the number of the program permitted to be reproduced is held in the program extractor 115 (step S504 in FIG. 5). In this manner, a program 303 to be reproduced during the non-sequential playback can be extracted. By subjecting all programs to this processing of determining whether or not the program is permitted to be reproduced (step S505 in FIG. 5), all information of the numbers of the programs to be non-sequentially reproduced in the playback blocks can be held in the program extractor 115. When region selection information RI is set to ‘003’ in the example shown in FIG. 3, PG#2, PG#3, and PG#4 are extracted as programs to be non-sequentially reproduced.

Thereafter, the system controller 112 acquires a non-sequential playback type flag 300 from the content index information 220 (a reference numeral 220A in FIG. 3) and advances the processing to the step of selecting a non-sequential playback type (step S404 in FIG. 4). In the first embodiment, it is assumed that an information zone of one bit is provided as a recording zone of the non-sequential playback type flag 300, and the set value is either ‘0’ or ‘1’. When the non-sequential playback type flag 300 is set to ‘1’, the program is reproduced in a random playback mode (step S405 in FIG. 4), and when the non-sequential playback type flag 300 is set to ‘0’, the program is reproduced in a shuffle playback mode (step S406 in FIG. 4). Both of the random playback mode and the shuffle playback mode belong to a non-sequential playback mode in which programs are read and reproduced non-sequentially, and a unique difference between them is whether or not the program is permitted to be read in an overlapping manner. In other words, the random playback mode allows the program to be reproduced in an overlapping manner and hence programs can be selected in order of PG#3, PG#1, and PG#3, that is, the programs 303 can be selected in an overlapping manner (PG#3 can overlap). In contrast to this, the shuffle playback mode does not allow the program to be reproduced in an overlapping manner. That is, the program once read is not read in an overlapping manner and programs are reproduced in a non-overlapping order such as the order of PG#3, PG#1, and PG#4.

Thereafter, the system controller 112 selects programs non-sequentially by the number of repeats RN set in the non-sequential playback repeat number information, stored in step S402 (steps S405, S407, or steps S406, S408)

In the first embodiment, the non-sequential playback type is set to 1 (that is, RT=1), so that a case will be described in which programs are reproduced in the random playback mode (step S405 in FIG. 4). In the random playback mode, first, in the step of apparatus information acquisition processing (step S410 in FIG. 4), a program to be selected during the non-sequential playback is extracted and then the random number generator 116 generates random numbers within the range of the total sum of the values of the playback permission flags of the programs extracted by the program extractor 115, whereby the programs at the time of playback are selected.

In the first embodiment, as shown in FIG. 6, in the program extractor 115 is stored information relating to three programs 303 of PG#2, PG#3, and PG#4 (for example, a program number (PG #number)). That is, it is assumed that the playback permission flags of the respective programs are a value of 1, and a value obtained by dividing this value of 1 by the total sum (that is, 1+1+1=3) of the values of the playback permission flags of PG#2, PG#3, and PG#4 becomes a probability that the respective programs are selected at the time of the random playback mode. A shown in FIG. 6, the programs of PG#2, PG#3, and PG#4 are selected at the probabilities of 1/3, 1/3, and 1/3, respectively.

Then, the random number generator 116 generates random numbers within the range from 1 to 3, and when a value of 1 is generated as a random number, PG#2 is selected, when a value of 2 is generated as a random number, PG#3 is selected, and when a value of 3 is generated as a random number, PG#4 is selected. By this processing, a program corresponding to a generated random number is selected. A case will be described below in which PG#3 is selected.

The system controller 112 issues a command to the playback drive 110 so that the program 303 of PG#3 is read from the DVD-ROM disk 100A. The read program 303 is encoded and decompressed by the program playback section 111 and is outputted as an analog image to the display section 120.

When the playback of PG#3 is finished, one is added to the number of playbacks (number of playback times) i in FIG. 4 and it is determined whether or not non-sequential playback is performed by the number of repeats RN which is the non-sequential playback repeat number information 301 (step S407 in FIG. 4). When the number of playbacks does not reach the number of repeats (number of repetition times) RN which is the non-sequential playback repeat number information 301, the processing of random playback is again performed. Since the random playback mode is selected, a program to be reproduced at random is newly selected from the programs 303 held at the present in the program extractor 115.

When the shuffle playback mode is selected in step S404, the processing proceeds to steps 406, 408 in FIG. 4. In step s406, a program once selected is removed from the programs to be selected by the program extractor 115.

As described above, in the first embodiment, a plurality of programs can be extracted from the DVD-ROM disk 100A in accordance with user-definable program selection condition information of the recording medium playback apparatus 101 and the program selection condition information of the DVD-ROM disk 100A, and the extracted programs can be reproduced non-sequentially. For this reason, it is possible to divide content data into categories and to share the data in the DVD-ROM disk 100A, and hence to dramatically increase the rate of use of the data in the DVD-ROM disk 100A.

### SECOND EMBODIMENT

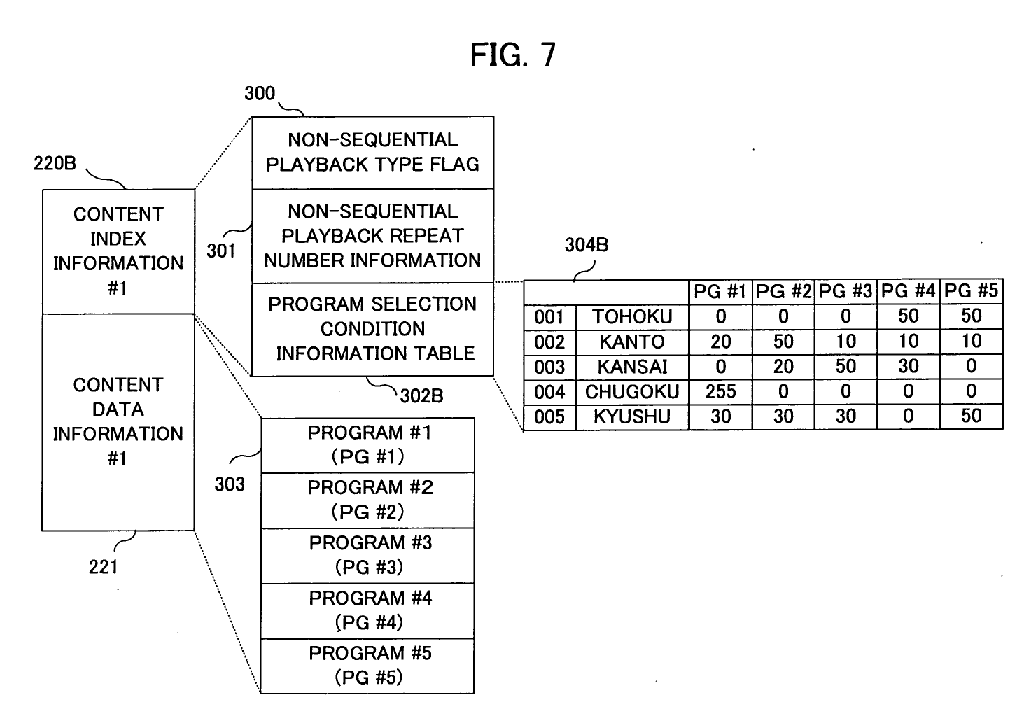

A portable recording medium 100B, a recording medium playback apparatus 102, and a recording medium playback method in the second embodiment will be described below. FIG. 7 is a diagram showing the internal structure of a playback block of a DVD-ROM disk 100B in the second embodiment. As shown in FIG. 7, in the second embodiment, content index information 220B has a program selection condition information table 302B which contains occurrence frequency parameter information for each playback unit. The construction of the DVD-ROM disk 100B in the second embodiment is the same, except for this point, as the construction of the DVD-ROM disk 100A in the first embodiment. Here, FIG. 1, FIG. 2, and FIG. 4 used in the description of the first embodiment are also referred to in the description of the second embodiment.

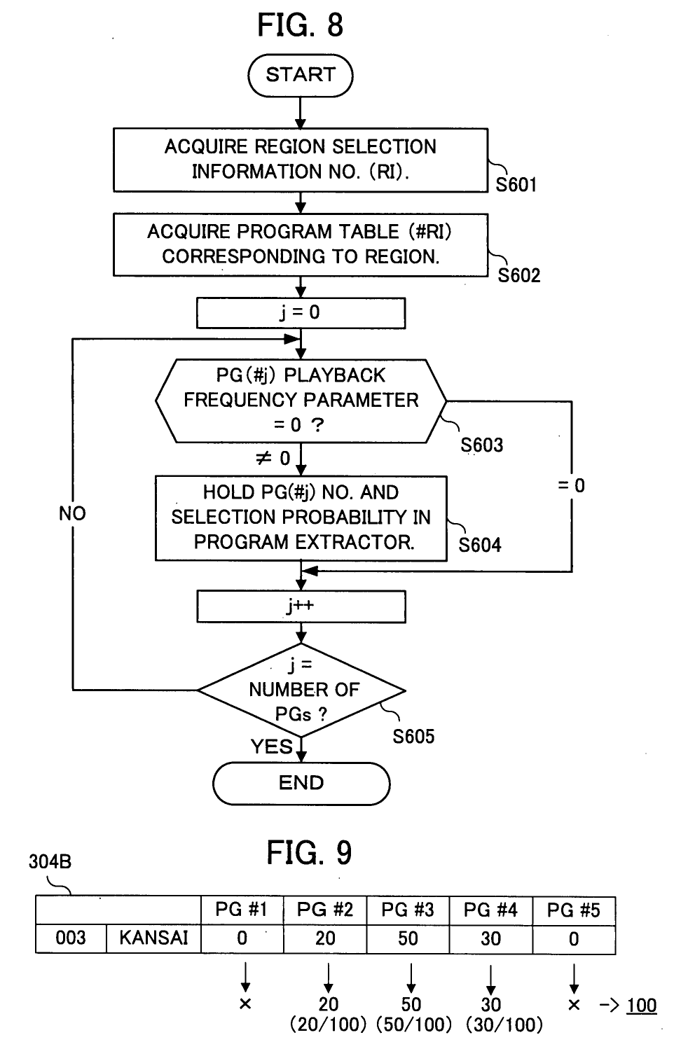

FIG. 8 is a flowchart showing the processing (step S410 in FIG. 4) by which the recording medium playback apparatus 102 in the second embodiment extracts a program to be proposed to be reproduced non-sequentially. Moreover, FIG. 9 is a diagram showing an algorithm structure of extracting a program (an example of computing a playback probability) from the DVD-ROM disk 100B during the non-sequential playback in the second embodiment.

An example of a playback processing operation to the playback block 230 of the DVD-ROM disk 100B in the second embodiment will be described by the use of FIG. 1, FIG. 2, FIG. 4, FIG. 7, FIG. 8, and FIG. 9. In the second embodiment will be described processing in a case in which the non-sequential playback type flag RT held in the content index information 220B is set to 1 (that is, set to random playback) and in which the number of repeats RN, which is the non-sequential playback repeat number information, is set to 3.

When the playback block 230 in the DVD-ROM disk 100B in the recording medium playback apparatus 102 is reproduced, first, the content index information 220 is read from the playback block 230 (step S401 in FIG. 4).

Next, the non-sequential playback repeat number information 301 is read from the content index information 220B. An information zone of seven bits is provided as the recording zone of the non-sequential playback repeat number information 301, and the range of a value to be set (the number of repeats) ranges from 0 to 127. A conditional branch to be described below is performed in accordance with the read value (step S402 in FIG. 4). When the non-sequential playback repeat number information 301 is set to a value of 0 (that is, when RN=0), the sequential playback of the normal playback mode is performed as a mode of reproducing the playback block 230 (step S403 in FIG. 4). The sequential playback is a playback mode of reproducing the playback block 230 in an order based on the content index information 220 of the DVD-ROM disk 100B (which is, in the first embodiment, also the order of recording the programs 303 recorded on the content data information 221, that is, the order of PG#1, PG#2, PG#3, PG#4, and PG#5). On the other hand, when a value other than 0 is set in the non-sequential playback repeat frequency information 301 (that is, when RN≠0), the system controller 112 determines that non-sequential playback is performed, stores the non-sequential playback repeat number information 301, and advances the processing to a step of apparatus information acquisition processing (step S410 in FIG. 4).

In the step of apparatus information acquisition processing (step S410 in FIG. 4) in the second embodiment, processing shown in a flowchart in FIG. 8 is executed. The system controller 112 acquires region selection information (user-definable program selection condition information) held in the region selection information storage 114 (step S601 in FIG. 8). As the region selection information is set a value within the range of the number of regions recorded on the program selection condition field 304B of the DVD-ROM disk 100B. For example, in FIG. 7, the program selection condition field 304B is divided into five regions, so the region selection information RI takes values within the range from ‘001’ to ‘005’. In the second embodiment, a case will be described in which a value of ‘003’ (that is, the “KANSAI” region) is set as region selection information RI. In this regard, the user-definable program selection condition information such as region selection information may be manually inputted by the user by the use of the user operation section 113, or may be previously inputted by the manufacturer in accordance with the sales region of the recording medium playback apparatus 102, or may be automatically set to the recording medium playback apparatus 102 through the network or the like connected by the user, or may be set from the menu screen to be described in the fifth embodiment.

The system controller 112 acquires the program selection condition field 304B corresponding to the value of region selection information stored in the recording medium playback apparatus 102 from the program selection condition information table 302B of the DVD-ROM disk 100B (step S602 in FIG. 8). In the second embodiment, it is assumed that the region selection information RI is ‘003’, so that the system controller 112 acquires the program selection condition field 304B of the “KANSAI” region (RI=003). As shown in FIG. 7, occurrence frequency parameter information of eight bits is held for each playback unit in the program selection condition field 304B. A value within a range from 0 to 255 can be set as the occurrence frequency parameter information. When a value of 255 is set, the value means that the probability that a program is selected in the random playback is the highest and when a value of 0 is set, the value means that a program is not selected in the random playback.

Next, the system controller 112 determines the occurrence frequency parameter of the program in the program selection condition field 304B (step S603 in FIG. 8) and holds a program number, for which a value of 0 is not set to the occurrence frequency parameter, and the occurrence frequency parameter in connection with each other in the program extractor 115 (step S604 in FIG. 8), thereby extracting a program to be selected at the time of random playback and having the information of the playback programs to which weights are assigned. All of the programs are subjected to this determination processing (step S605 in FIG. 8). Since RI=003, programs in which the value 0 is not set to the occurrence frequency parameter, that is, the programs of PG#2, PG#3, and PG#4 are extracted.

Thereafter, the system controller 112 acquires a non-sequential playback type flag 300 from the content index information 220 and advances the processing to the step of selecting a non-sequential playback type (step S404 in FIG. 4). It is assumed that an information zone of one bit is provided as the recording zone of the non-sequential playback type flag 300 and the set value is either ‘0’ or ‘1’. When the non-sequential playback type flag 300 is set to ‘1’, the program is reproduced in the random playback mode (step S405 in FIG. 4), and when the non-sequential playback type flag 300 is set to ‘0’, the program is reproduced in the shuffle playback mode (step S406 in FIG. 4).

Thereafter, the system controller 112 selects programs non-sequentially by the number of repeats RN set in the non-sequential playback repeat number information, stored in step S402 (steps S405, S407, or steps S406, S408).

In the second embodiment, the non-sequential playback type flag is set to ‘1’ (that is, RT=1), so that a case will be described in which programs are reproduced in the random playback mode (step S405 in FIG. 4). In the second embodiment, first, in the step of apparatus information acquisition processing (step S410 in FIG. 4), a program to be selected during the non-sequential playback is extracted, and then the random number generator 116 generates random numbers within the range of the total sum of the values of the occurrence frequency parameters of the programs extracted by the program extractor 115, whereby the programs at the time of playback are selected.

In the second embodiment, as shown in FIG. 9, in the program extractor 115 is stored information relating to three programs 303 of PG#2, PG#3, and PG#4 (for example, program numbers (PG #number) and their occurrence frequencies information). That is, probabilities obtained by dividing the respective occurrence frequency parameters of PG#2, PG#3, and PG#4 by the total sum of the values of the occurrence frequency parameters of PG#2, PG#3, and PG#4 become probabilities that the respective programs are selected at the time of random playback mode. That is, the programs of PG#2, PG#3, and PG#4 are selected at the probabilities of 20/100, 50/100, and 30/100, respectively.

Then, the random number generator 116 generates random numbers within the range of the total sum of the occurrence frequency parameters of the programs selected by the program extractor 115. In the second embodiment, random numbers are generated within a range from 1 to 100. When a value within a range from 1 to 20 is generated as a random number, PG#2 is selected, when a value within a range from 21 to 70 is generated as a random number, PG#3 is selected, and when a value within a range from 71 to 100 is generated as a random number, PG#4 is selected. As shown by the computation example like this, a program corresponding to a generated random number is selected. In the second embodiment will be described a case in which PG#3 is selected.

The system controller 112 issues a command to the playback drive 110 so that the program 303 of PG#3 is read from the DVD-ROM disk 100B. The read program 303 is encoded and decompressed by the program playback section 111 and is outputted as an analog image to the display section 120.

When the playback of PG#3 is finished, one is added to the number of playbacks i in FIG. 4 and it is determined whether or not non-sequential playback is performed by the number of repeats RN which is the non-sequential playback repeat number information 301 (step S407 in FIG. 4). When the number of playbacks does not reach the number of repeats RN which is the non-sequential playback repeat number information 301, the processing of random playback is again performed. Since the random playback mode is selected, a program to be reproduced at random is newly selected in the programs 303 held at the present in the program extractor 115. On the other hand, when the shuffle playback mode is selected, a program once selected is removed from the programs to be selected by the program extractor 115.

As described above, according to the second embodiment, a plurality of programs are extracted from the DVD-ROM disk 100B in accordance with user-definable program selection condition information of the recording medium playback apparatus 102 and the program selection condition information of the DVD-ROM disk 100B, and the extracted programs can be reproduced non-sequentially. For this reason, it is possible to divide content data into categories and to share the data in the DVD-ROM disk 100B, and hence to dramatically increase the rate of use of the data in DVD-ROM disk 100B. Moreover, according to the second embodiment, the content supplier can freely and easily set the rate of occurrence of a program that the supplier wants to urge the user to view even in the random playback by utilizing the program selection condition field 304B related to the user-definable program selection condition information held in the recording medium playback apparatus 102. When the content supplier manufactures a random playback disk designed for CM contents, this function makes it possible for the supplier to easily urge the user to select a program at a rate depending on a sponsor charge.

### THIRD EMBODIMENT

A portable recording medium 100C, a recording medium playback apparatus 103, and a recording medium playback method in the third embodiment will be described below. In a DVD-ROM disk 100C of the third embodiment, the content index information includes a flag showing the presence or absence and the type of non-sequential playback of a program in content data information, information of the number of repeats of a program during the non-sequential playback, and an expiration date information table. The DVD-ROM disk 100C of the third embodiment is different from the DVD-ROM disk 100A of the first embodiment in that the expiration date information table contains viewing expiration information of each program unit.

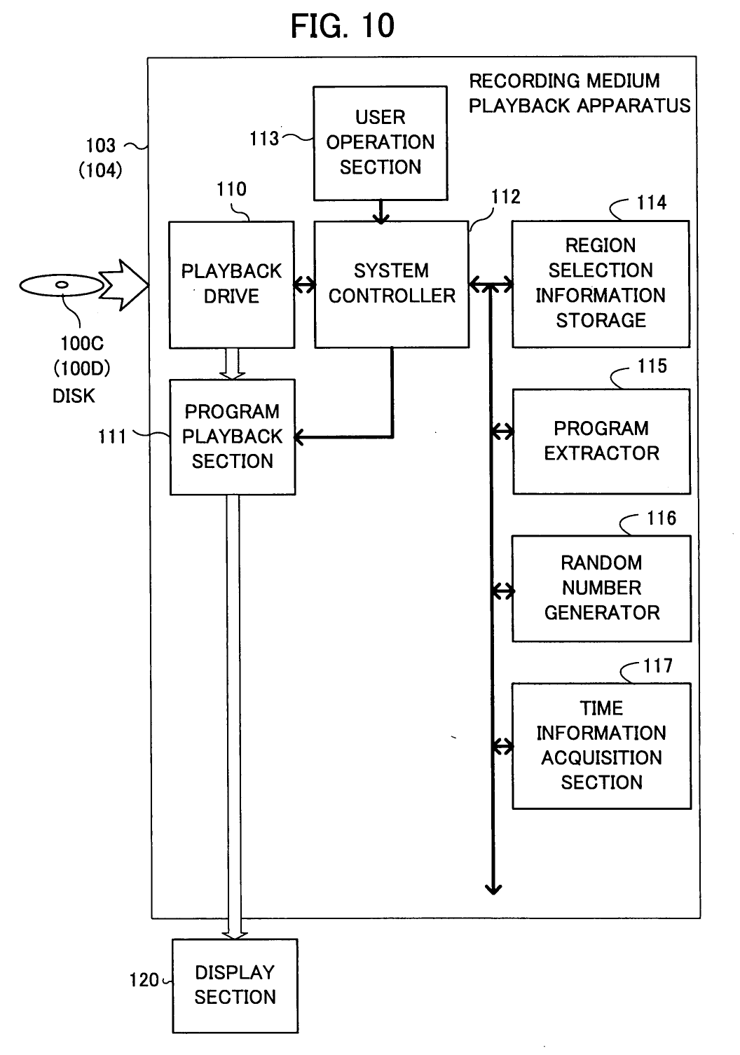

FIG. 10 is a block diagram schematically showing a configuration of the recording medium playback apparatus 103 in the third embodiment. In FIG. 10, constituent elements that are the same as or correspond to those in FIG. 1 are assigned the same reference numerals or symbols. As shown in FIG. 10, the recording medium playback apparatus 103 reproduces programs recorded on the DVD-ROM disk 100C. The recording medium playback apparatus 103 includes the playback drive 110 which reads information from the DVD-ROM disk 100C; the program playback section 111 which decompresses a coded compressed signal read from the DVD-ROM disk 100C to produce an analog image; the system controller 112 which controls the whole of the recording medium playback apparatus 103 in an integrated manner; and the user operation section 113 in which the user inputs data to the system controller 112. Moreover, the recording medium playback apparatus 103 includes the region selection information storage 114 which stores apparatus playback region information inputted from the user operation section 113; and the program extractor 115 which extracts a program to be selected in non-sequential playback on the basis of apparatus playback region information of the region selection information storage 114 during the non-sequential playback; and the random number generator 116 which generates random numbers. The program extractor 115 selects a program to be reproduced next from a group of extracted programs in accordance with a random number generated by the random number generator 116. The program playback section 111 converts the selected program into analog image signals in accordance with a command from the system controller 112 and sends the analog image signals to the display section 120. Moreover, the recording medium playback apparatus 103 includes a time information acquisition section 117 which holds present time information. The present time information held in the time information acquisition section 117 may be manually inputted from the user operation section 113 by the user, or may be inputted from a network. The present time information held by the time information acquisition section 117 may be acquired by a time function (date and time management function) held by the time information acquisition section 117.

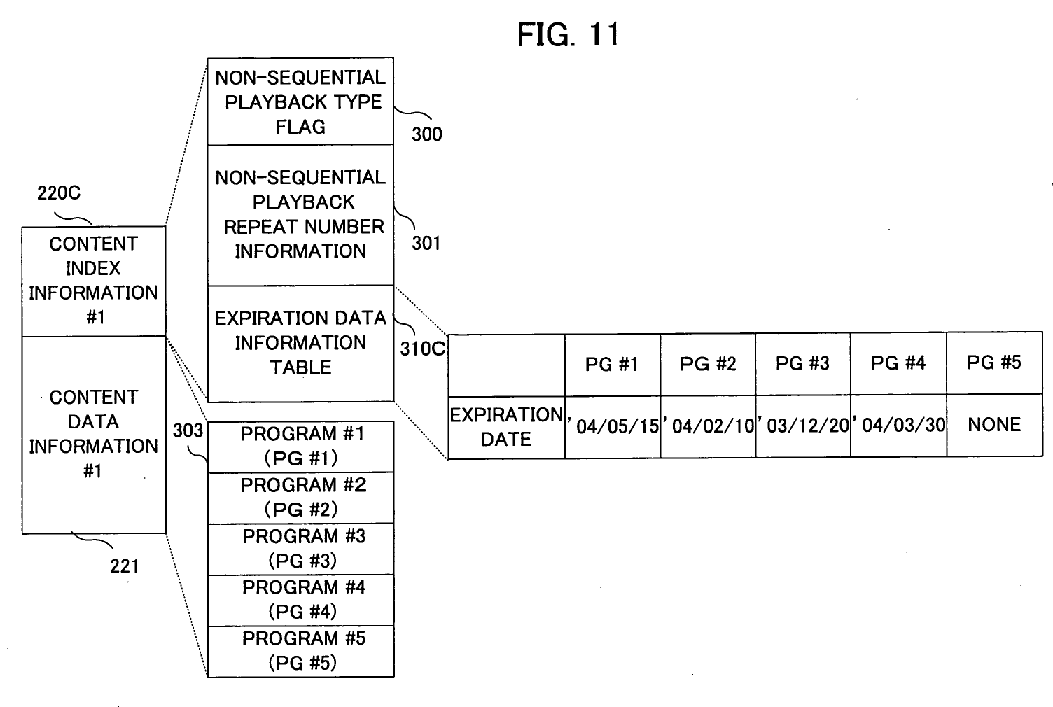

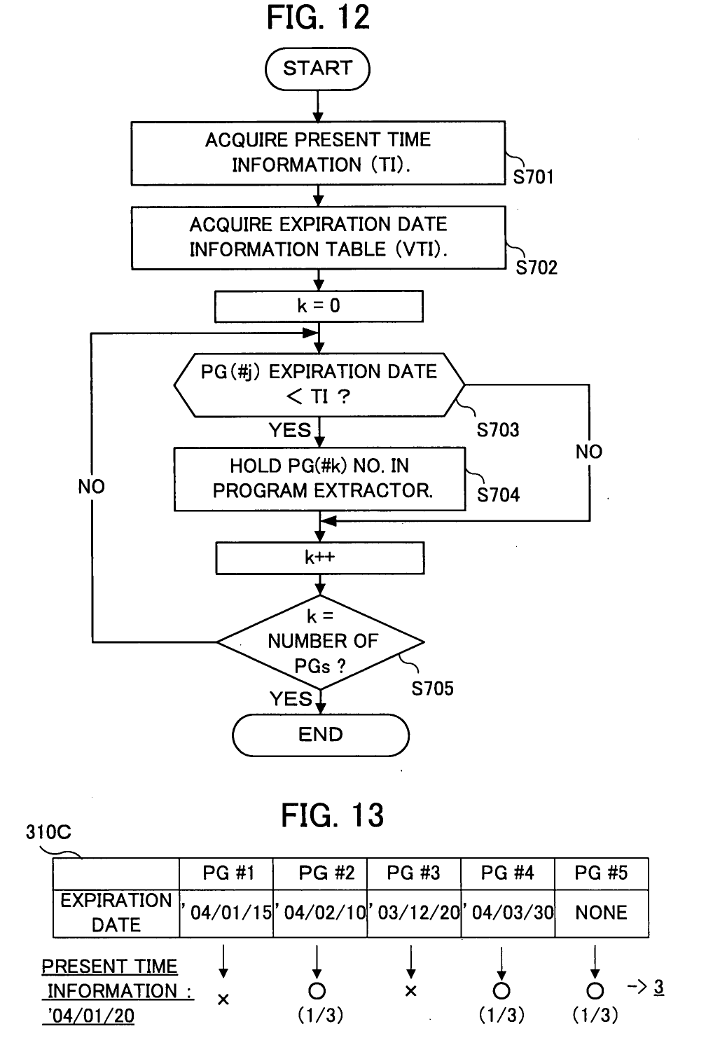

FIG. 11 is a diagram showing an example of the internal structure of a playback block 230 of the DVD-ROM disk 100C in the third embodiment. In FIG. 11, constituent elements that are the same as or correspond to those in FIG. 3 are assigned the same reference numerals or symbols. As shown in FIG. 11, content index information 220C has an expiration date information table 310C which contains expiration date information for each playback unit.

Moreover, FIG. 12 is a flowchart showing the processing (step S410 in FIG. 4) by which the recording medium playback apparatus 102 in the third embodiment extracts a program to be proposed to be reproduced non-sequentially. Further, FIG. 13 is a diagram showing an algorithm structure of extracting a program (an example of computing the number of playbacks) from the DVD-ROM disk 100C in the third embodiment.

A playback processing operation to the playback block 230 in the third embodiment will be described by the use of FIG. 2, FIG. 4, FIG. 10, FIG. 11, FIG. 12, and FIG. 13. In the third embodiment will be described processing in a case in which the non-sequential playback type flag RT held in the content index information 220A is set to ‘1’ (that is, set to random playback) and in which the number of repeats RN, which is the non-sequential playback repeat number information, is set to 3.

When the playback block 230 of the DVD-ROM disk 100C is reproduced by the recording medium playback apparatus 103, the system controller 112 first reads the content index information 220 from the playback block 230 (step S401 in FIG. 4).

Next, the system controller 112 reads the non-sequential playback repeat number information 301 from the content index information 220. In the third embodiment, an information zone of seven bits is provided as the recording zone of the non-sequential playback repeat number information 301, and a value to be set (the number of repeats) ranges from 0 to 127. A conditional branch to be described below is performed in accordance with the read value (step S402 in FIG. 4). When the non-sequential playback repeat number information 301 is set to a value of 0 (that is, when RN=0), the sequential playback of the normal playback mode is performed as a mode of reproducing the playback block 230 (step S403 in FIG. 4). On the other hand, when the non-sequential playback repeat number information 301 is set to a value other than 0, the system controller 112 determines that non-sequential playback is performed, stores the non-sequential playback repeat number information 301, and advances the processing to the step of apparatus information acquisition processing (step S410 in FIG. 4).

In the step of apparatus information acquisition processing (step S410 in FIG. 4) in the third embodiment, the processing shown in the flowchart in FIG. 12 is executed. The system controller 112 acquires present time information (step S701 in FIG. 12). It is assumed that the present time information is held as numeral information of six digits. The numeral information of the present time information is held in the form of “YYMMDD”, and the first two digits YY indicate “the last two digits of the dominical year”, the next two digits MM indicate a “month”, and the last two digits DD indicate a “day”. It is assumed that the respective pieces of numeral information are recorded on the BCD format. However, severer time management may be performed by diving time information into finer units (for example, by making time information include units of time and minute).

Next, the system controller 112 reads the expiration date information table 310C of the DVD-ROM disk 100C to acquire expiration date information of each of the programs (step S702 in FIG. 12). The information of expiration date until which each of the programs is permitted to be reproduced is held in the same format as the present time information held in the time information acquisition section 117. That is, the numeral information of six digits of the same format is recorded for each of the programs.

When the present time is compared with the expiration date information of each of the programs (step S703 in FIG. 12) and the present time exceeds the expiration date information for a program, it is determined that this program is inhibited from being reproduced. Conversely, when the present time is within the expiration date information of a program, it is determined that this program is permitted to be reproduced and its program number that is permitted to be reproduced is held in the program extractor 115 (step S704 in FIG. 12), whereby the program to be reproduced at random is extracted. All programs are subjected to this processing of determining whether or not the program is permitted to be reproduced (step S705 in FIG. 12). In the third embodiment, the present time information is “04/01/20”, that is, 20 Jan. 2004, so that the programs to be reproduced at random become PG#2, PG#4, and PG#5 for which expiration date information exceeding the present time of “04/01/20” are set.

Thereafter, the system controller 112 acquires the non-sequential playback type flag 300 from the content index information 220 and advances the processing to the step of selecting the type of non-sequential playback (step S404 in FIG. 4). It is assumed that an information zone of one bit is provided as the recording zone of the non-sequential playback type flag 300 and the set value is either ‘0’ or ‘1’. When the non-sequential playback type flag 300 is set to ‘1’, the program is reproduced in the random playback mode (step S405 in FIG. 4), and when the non-sequential playback type flag 300 is set to ‘0’, the program is reproduced in the shuffle playback mode (step S406 in FIG. 4).

Thereafter, programs are selected non-sequentially by the number of repeats RN set in the non-sequential playback repeat number information, stored in step S402 (steps S405, S407, or steps S406, S408).

In the third embodiment, the non-sequential playback type is set to 1 (that is, RT=1), so that a case will be described in which programs are reproduced in the random playback mode (step S405 in FIG. 4). In the third embodiment, first, in the step of apparatus information acquisition processing (step S410 in FIG. 4), a program to be selected during the non-sequential playback is extracted, and then the random number generator 116 generates random numbers within the range of the total sum of the values of the playback permission flags of programs extracted by the program extractor 115.

In the third embodiment, as shown in FIG. 13, in the program extractor 115 is stored information relating to three programs 303 of PG#2, PG#4, and PG#5 (for example, a program number (PG #number)). That is, it is assumed that the playback permission flags of the respective programs are a value of 1, and a value obtained by dividing this value of 1 by the total sum (that is, 1+1+1=3) of the values of the playback permission flags of PG#2, PG#3, and PG#4 becomes a probability that the respective programs are selected at the time of random playback (selection probability or occurrence probability). A shown in FIG. 6, the programs of PG#2, PG#3, and PG#4 are selected at the probabilities of 1/3, 1/3, and 1/3, respectively.

Then, the random number generator 116 generates random numbers within the range from 1 to 3. When a value of 1 is generated as a random number, PG#2 is selected, when a value of 2 is generated as a random number, PG#3 is selected, and when a value of 3 is generated as a random number, PG#4 is selected. By the processing like this, a program corresponding to a generated random number is selected. A case will be described below in which PG#4 is selected.

The system controller 112 issues a command to the playback drive 110 so that the program 303 of PG#4 is read from the DVD-ROM disk 100C. The read program 303 is encoded and decompressed by the program playback section 111 and is outputted as an analog image to the display section 120.

When the playback of PG#4 is finished, one is added to the number of playback i in FIG. 4 and it is determined whether or not non-sequential playback is performed by the number of repeats RN which is the non-sequential playback repeat number information 301 (step S407 in FIG. 4). When the number of playbacks does not reach the number of the non-sequential playback repeat number information 301, the processing of random playback is again performed. Since the random playback mode is selected, a program to be reproduced at random is newly selected from the programs 303 held at the present in the program extractor 115. On the other hand, when the shuffle playback mode is selected, a program once selected is removed from programs to be selected by the program extractor 115.

As described above, according to the third embodiment, when a program having an expiration date such as event information and commercial information programs are reproduced at random, the program is not automatically extracted after the expiration date by utilizing the present time information held in the recording medium playback apparatus 103 and the program selection condition information of the DVD-ROM disk 100C. In this manner, supplying the user with false information can be prevented, so that it is possible to supply the user with contents of high reliability.

### FOURTH EMBODIMENT

A portable recording medium 100D, a recording medium playback apparatus 104, and a recording medium playback method in the fourth embodiment will be described below. The fourth embodiment is different from the third embodiment in that the portable recording medium has the occurrence frequency parameters of the respective programs.

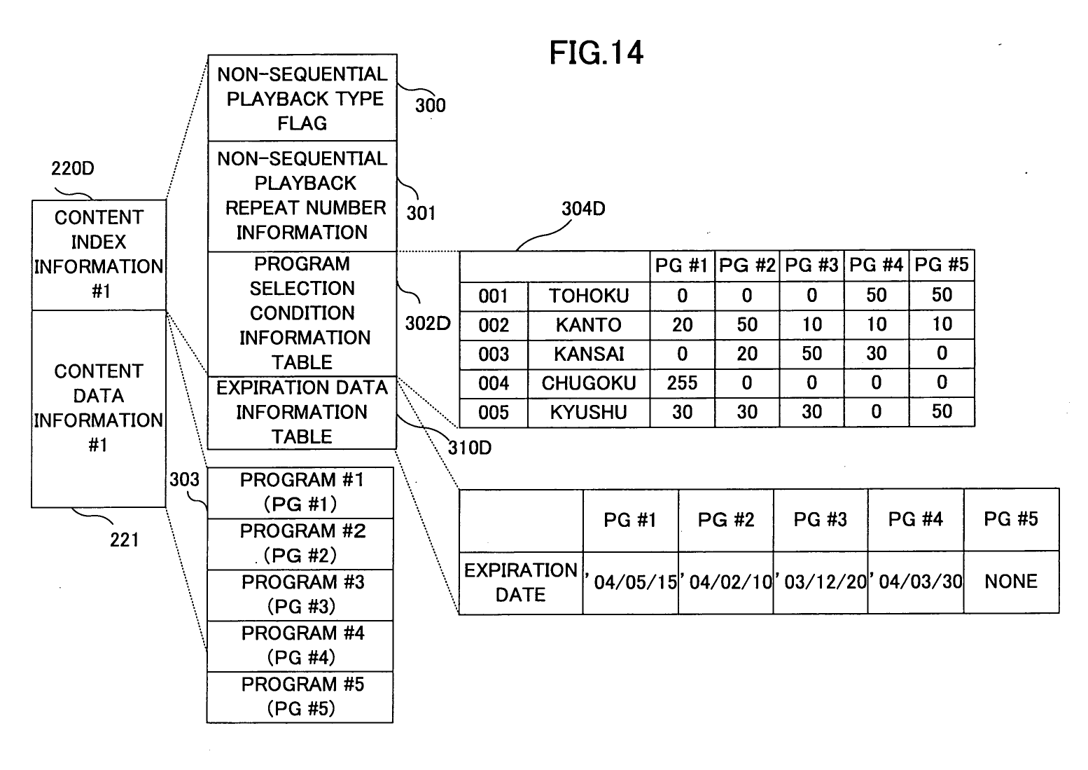

FIG. 14 is a diagram showing an example of the internal structure of the playback block 230 of the DVD-ROM disk 100D in the fourth embodiment. In FIG. 14, constituent elements that are the same as or correspond to those in FIG. 1 are assigned the same reference numerals or symbols. As shown in FIG. 14, the playback block 230 includes two kinds of information of content index information 220D and content data information 221. The content data information 221 includes a plurality of programs (PG) of a minimum unit of playback control. Moreover, the content index information 220D includes information such as the order of playback of the plurality of programs stored in the content data information, the presence or absence and the type of non-sequential playback, and the number of repeats in the non-sequential playback. Further, the content index information 220D includes a program selection condition information table 302D which contains the occurrence frequency parameter information for each playback unit and similarly an expiration date information table 310D which contains information of an expiration date, until which playback is permitted to be reproduced, for each playback unit.

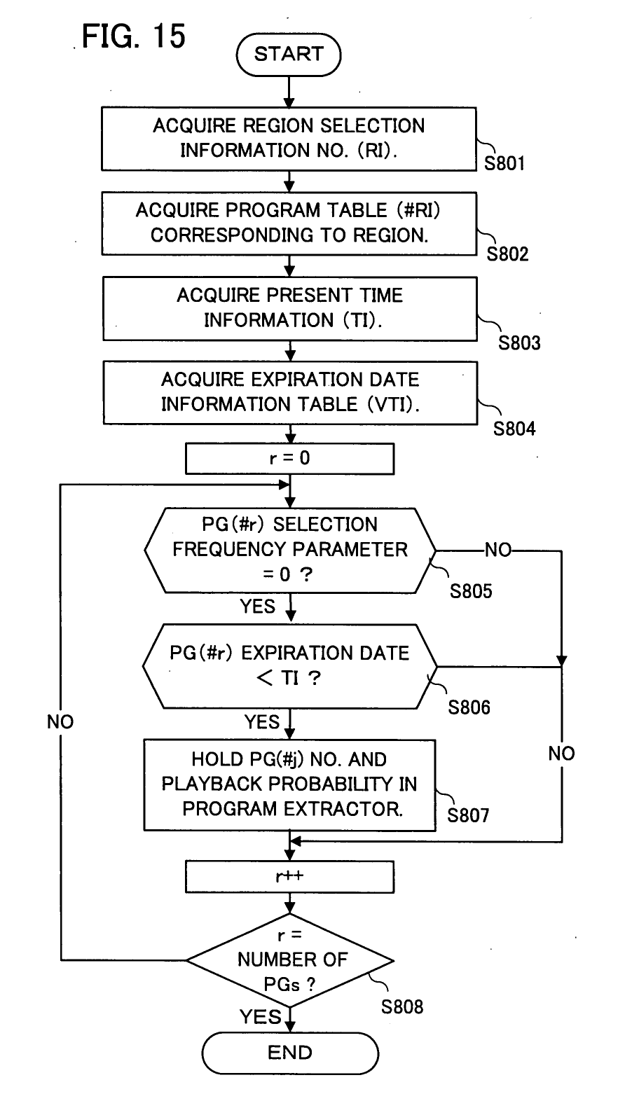

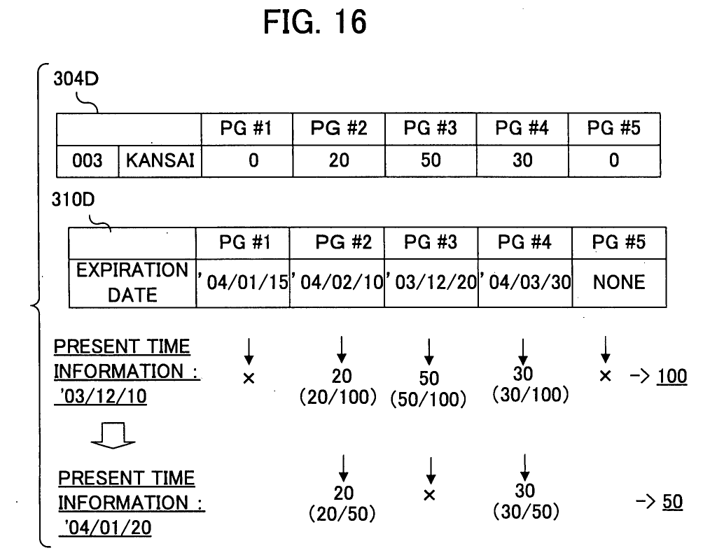

FIG. 15 is a flowchart showing the processing (step S410 in FIG. 4) by which the recording medium playback apparatus 104 in the fourth embodiment extracts a program to be proposed to be reproduced non-sequentially. Further, FIG. 16 is a diagram showing an algorithm structure of extracting a program (an example of computing the number of playbacks) from the DVD-ROM disk 100D during the non-sequential playback in the fourth embodiment.

An example of a playback processing operation to the playback block 230 of the DVD-ROM disk 100D in the fourth embodiment will be described by the use of FIG. 2, FIG. 4, FIG. 10, FIG. 14, FIG. 15, and FIG. 16. In the fourth embodiment will be described processing in a case in which the non-sequential playback type flag RT held in the content index information 220D is set to ‘1’ (that is, set to random playback) and in which the number of repeats RN based on the non-sequential playback repeat number information is set to 3.

When the playback block 230 in the DVD-ROM disk 100D is reproduced by the recording medium playback apparatus 104, first, the content index information 220 is read from the playback block 230 (step S401 in FIG. 4).

Next, the non-sequential playback repeat number information 301 is read from the content index information 220D. An information zone of seven bits is provided as the recording zone of the non-sequential playback repeat number information 301, and a value to be set (the number of repeats) ranges from 0 to 127. A conditional branch to be described below is performed in accordance with the read value (step S402 in FIG. 4). When a value of 0 is set in the non-sequential playback repeat number information 301 (that is, when RN=0), the sequential playback of the normal playback mode is performed as the mode of reproducing the playback block 230 (step S403 in FIG. 4). On the other hand, when a value other than 0 is set in the non-sequential playback repeat number information 301, the system controller 112 determines that non-sequential playback is performed, stores the non-sequential playback repeat number information 301, and advances the processing to the step of apparatus information acquisition processing (step S410 in FIG. 4).

In the step of apparatus information acquisition processing (step S410 in FIG. 4) in the fourth embodiment, processing shown in the flowchart in FIG. 15 is executed. The system controller 112 acquires region selection information (user-definable program selection condition information) held in the region selection information storage 114 (step S801 in FIG. 15). As the region selection information is set a value within the range of the number of regions recorded on the program selection condition field 304B in the DVD-ROM disk 100D. For example, in FIG. 14, the program selection condition field 304D is divided into five regions, so the region selection information RI takes values in the range from ‘001’ to ‘005’. In the fourth embodiment will be described a case in which a value of ‘003’ (that is, the “KANSAI” region) is set as region selection information RI. In this regard, the user-definable program selection condition information such as region selection information may be manually inputted by the user by the use of the user operation section 113, or may be previously inputted by the manufacturer in accordance with the sales region of the recording medium playback apparatus 104, or may be automatically set to the recording medium playback apparatus 104 through the network or the like connected by the user, or may be set from the menu screen to be described in the fifth embodiment.

The system controller 112 acquires the program selection condition field 304D corresponding to the value of region selection information stored in the recording medium playback apparatus 104 from the program selection condition information table 302D of the DVD-ROM disk 100D (step S802 in FIG. 15). In the fourth embodiment, it is assumed that the region selection information RI is ‘003’, so that the system controller 112 acquires the program selection condition field 304D of the “KANSAI” region (RI=003). As shown in FIG. 14, an occurrence frequency parameter information of eight bits is held for each playback unit in the program selection condition field 304D. A value within a range from 0 to 255 can be set as the occurrence frequency parameter information. When a value of 255 is set, the value means that a probability that a program is selected in the random playback is the highest, and when a value of 0 is set, the value means that a program is not selected at the time of random playback.

Next, the system controller 112 acquires present time information held in the time information acquisition section 117 (step S803 in FIG. 15). The present time information is held, for example, as numeral information of six digits. The numeral information of the present time information is held, for example, in the form of “YYMMDD”, and the first two digits YY indicate “the last two digits of the dominical year”, the next two digits MM indicate a “month”, and the last two digits DD indicate a “day”. The respective pieces of numeral information are recorded on the BCD format.

Next, the system controller 112 reads the expiration date information table 310D of the DVD-ROM disk 100D to acquire expiration date information of each of the programs (step S804 in FIG. 15). The information of expiration date until which each of the programs is permitted to be reproduced is held in the same format as the present time information held in the time information acquisition section 117. That is, the numeral information of six digits of the same format is recorded for each of the programs.

Next, the system controller 112 determines the occurrence frequency parameter of the program of the program selection condition field 304D (step S805 in FIG. 15), that is, whether or not a value of 0 is not set to the occurrence frequency parameter of the program number. The present time information is compared with the expiration date information of each of the programs among the programs having a value other than 0 is set to the occurrence frequency parameter (step S806 in FIG. 15). When the present time information is within the expiration data information of the program, it is determined that the program is permitted to be reproduced, so the program number of the program permitted to be reproduced and the occurrence frequency parameter are held in connection with each other in the program extractor 115 (step S807 in FIG. 15). In this manner, a program to be reproduced at random is extracted. All programs are subjected to this processing of determining whether or not a program is permitted to be reproduced (step S808 in FIG. 15).

In the fourth embodiment, RI=003, so PG#2, PG#3, and PG#4 are extracted. Then, the expiration date information of each of the extracted programs is compared with the present time information. In the fourth embodiment, the present time information is “03/12/10”, so it is determined that all programs hold effective expiration date information with respect to the present time, and PG#2, PG#3, and PG#4 are extracted and are held in the program extractor 115 in connection with their occurrence frequency parameters of the program 303.

Then, the system controller 112 acquires the non-sequential playback type flag 300 from the content index information 220 and advances the processing to the step of selecting the type of non-sequential playback (step S404 in FIG. 4). It is assumed that an information zone of one bit is provided as the recording zone of the non-sequential playback type flag 300 and the set value is either ‘0’ or ‘1’. When the non-sequential playback type flag 300 is set to ‘1’, the program is reproduced in the random playback mode (step S405 in FIG. 4), and when the non-sequential playback type flag 300 is set to ‘0’, the program is reproduced in the shuffle playback mode (step S406 in FIG. 4).

In the fourth embodiment, as shown in FIG. 16, in the program extractor 115 is stored information relating to three programs 303 of PG#2, PG#4, and PG#5 (for example, a program number (PG #number) and their occurrence frequency information). Probabilities obtained by dividing the respective occurrence frequency parameters of the respective programs by the total sum of the values of the occurrence frequency parameters of PG#2, PG#3, and PG#4 become probabilities that the respective programs are selected at the time of random playback. That is, the programs of PG#2, PG#3, and PG#4 are selected at the probabilities of 20/100, 50/100, and 30/100, respectively.

Then, the random number generator 116 generates random numbers within a range from 1 to 100. When a value within a range from 1 to 20 is generated as a random number, PG#2 is selected, when a value within a range from 21 to 70 is generated as a random number, PG#3 is selected, and when a value within a range from 71 to 100 is generated as a random number, PG#4 is selected. By this processing, a program corresponding to a generated random number is selected. In the fourth embodiment, a case in which PG#3 is selected will be described.

The system controller 112 issues a command to the playback drive 110 so that the program 303 of PG#3 is read from the DVD-ROM disk 100. The read program 303 is encoded and decompressed by the program playback section 111 and is outputted as an analog image to the display section 120.

When the playback of PG#3 is finished, one is added to the number of playbacks i in FIG. 4 and it is determined whether or not non-sequential playback is performed by the number of repeats RN which is the non-sequential playback repeat number information 301 (step S407 in FIG. 4). When the number of playbacks does not reach the number of repeats RN which is the non-sequential playback repeat number information 301, the processing of random playback is again performed. Since the random playback mode is selected, a program to be reproduced at random is newly selected from the programs 303 held at the present in the program extractor 115. On the other hand, when the shuffle playback mode is selected, a program once selected is removed from the program extractor 115.

A case, in which after a specified time elapses thereafter, the same DVD-ROM disk 100D is reproduced, will be described. The same processing is performed to the step (step S805 in FIG. 15) of determining whether or not the occurrence frequency parameter of the program of the program selection condition field 304D is zero. For this reason, because RI=003, which is the same as the last time, the programs extracted by the occurrence frequency parameter become PG#2, PG#3, and PG#4. Thereafter, the expiration date information of each of the extracted programs is compared with the present time information. In the fourth embodiment, since the present time information is “04/01/20”, PG#2 and PG#4 that hold expiration date information effective to the present time are extracted, and their program numbers and occurrence frequency parameters are held in the program extractor 115 in connection with each other.

In the fourth embodiment, an algorithm by which a program is selected by the use of a random number is shown in FIG. 16. That is, probabilities obtained by dividing the respective occurrence frequency parameters of the respective programs of PG#2, PG#3, and PG#4 by the total sum of the values of the occurrence frequency parameters become probabilities that the respective programs are selected at the time of random playback (selection probability or occurrence probability). That is, the selection probabilities of the programs PG#2 and PG#4 are again computed, and the programs PG#2 and PG#4 are hence selected at the probabilities of 20/50 and 30/50, respectively.

In this manner, it is possible to provide the recording medium playback apparatus 104 that does not extract the expired programs at the time of random playback and hence can compute the occurrence probabilities of the programs so as to automatically assign the occurrence probabilities of the programs to the extracted programs, and the recording medium therefor.

Then, the random number generator 116 generates random numbers within the range of the total sum of the occurrence frequency parameters of the programs selected by the program extractor 115. In the fourth embodiment, random numbers are generated within a range from 1 to 50. When a value within a range from 1 to 20 is generated as a random number, PG#2 is selected, when a value within a range from 21 to 50 is generated as a random number, PG#4 is selected. In this manner, a program corresponding to a generated random number is selected. In the fourth embodiment will be described a case in which PG#4 is selected.

Then, the system controller 112 issues a command to the playback drive 110 so that the program 303 of PG#3 is read from the DVD-ROM disk 100D. The read program 303 is encoded and decompressed by the program playback section 111 and is outputted as an analog image to the display section 120.

When the playback of PG#4 is finished, it is determined whether or not non-sequential playback is performed by the number of repeats which is the non-sequential playback repeat number information 301 (step S407 in FIG. 4). When the number of playbacks does not reach the number of repeats which is the non-sequential playback repeat number information 301, the processing of random playback is again performed. Since the random playback mode is selected, a program to be reproduced at random is newly selected in the programs 303 held at the present in the program extractor 115. On the other hand, when the shuffle playback mode is selected, a program once selected is removed from the program extractor 115, thereby being excluded from the next selection.

As described above, according to the fourth embodiment, it is possible to freely and easily set the rate of occurrence of a program that the user is urged to view even in random playback. Further, when a program having an expiration date is reproduced non-sequentially, the program cannot automatically be extracted after the expiration date, so that it is possible to make effective use of the contents.

### FIFTH EMBODIMENT

A portable recording medium 100E, a recording medium playback apparatus 105, and a recording medium playback method in the fifth embodiment will be described below. In the first to fourth embodiments, the cases, in which the region number in the program selection condition information table held in the disk is specified, have been described on the basis of the user-definable program selection condition information held previously in the recording medium playback apparatus. In the fifth embodiment, however, a mode, in which the user-definable program selection condition information is not held previously in the recording medium playback apparatus but is set from a menu screen displayed, will be described on the basis of the menu screen content data information in the apparatus. The following description will be provided by a method in accordance with the description of the first embodiment, but the fifth embodiment can be applied to the second to fourth embodiments.

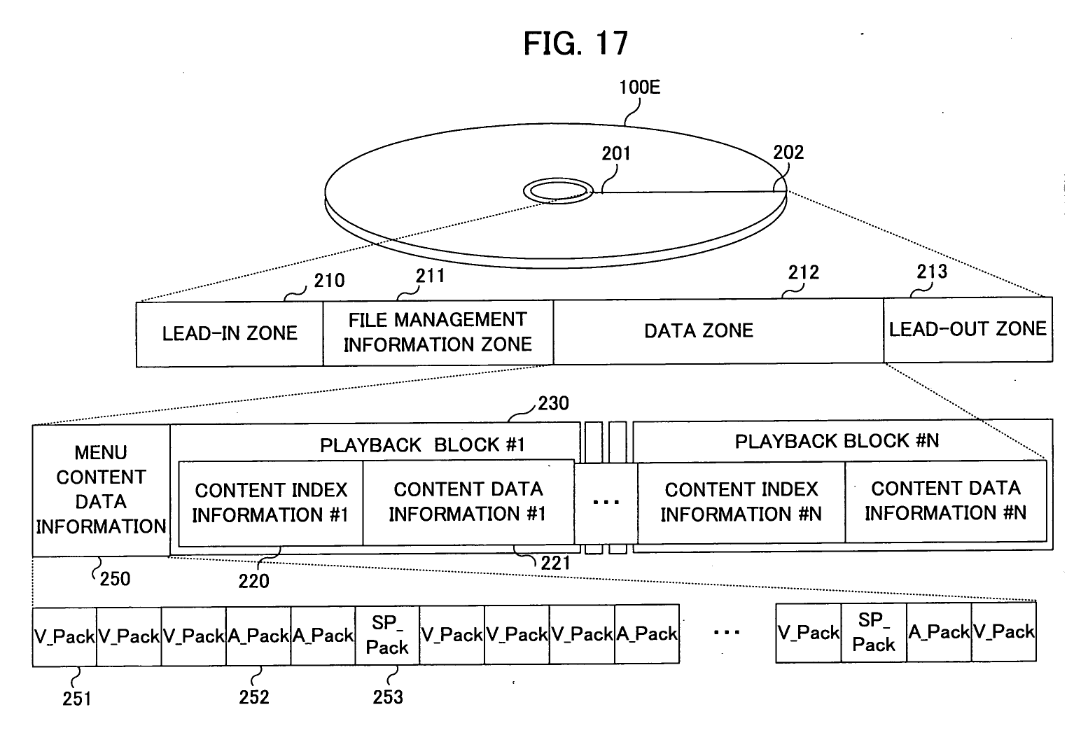

FIG. 17 is a diagram showing an example of an internal data structure of a DVD-ROM disk 100E in the fifth embodiment. A data zone 212 includes content data information 250 for a menu screen and at least one playback block 230. The content data information 250 for a menu screen has a plurality of kinds of pack data interleaved therein such as an image pack (V-Pack) 251, a voice pack (A-Pack) 252, and a sub-image pack (SP-Pack) 253. The data sizes of the respective kinds of pack data are equal to each other, and digital data information, which constitutes image data information, voice data information, and sub-image data information, respectively, can be obtained by collecting and again integrating the respective kinds of pack data. In FIG. 17 is shown an example in which digital data information is divided into three kinds of pack information of the image data information, the voice data information, and the sub-image data information. However, the voice data may not exist. Moreover, in addition to the three kinds of pack information shown in FIG. 17, pack information of kinds having different purposes such as still image data, control data, and the like may be included. In the other constructions, the DVD-ROM disk 100E is the same as the DVD-ROM disk 100A described in the first embodiment.

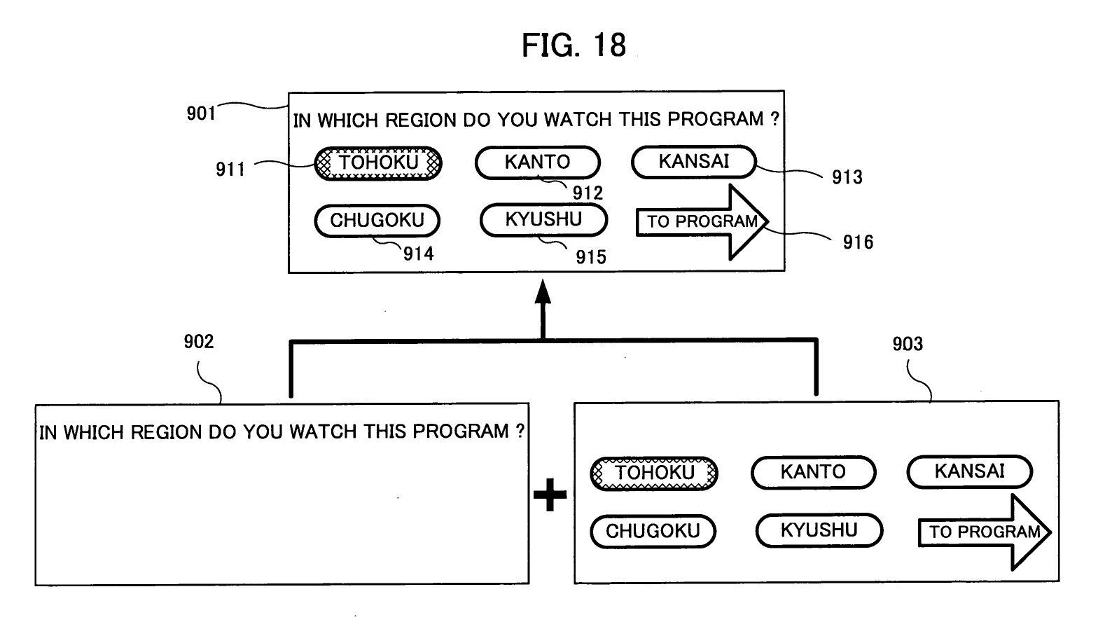

FIG. 18 is a diagram showing a menu screen displayed on the display section 120 when the content data information 250 for a menu screen of the DVD-ROM 100E is reproduced by the recording medium playback apparatus 105 in the fifth embodiment. As shown in FIG. 18, a menu screen 901 includes a combination of image data information 902 and sub-image data information 903. The image data information 902 is background image information on the menu screen and the sub-image data information 903 shows button information superimposed on the image data information 902.

In FIG. 18, the sub-image data information 903 has six pieces of button information, and five buttons 911, . . . , 915 show buttons for setting region selection information and a button 916 shows a button for starting to reproduce a target program. In the menu screen 901, only one of the now selected buttons is highlighted. In FIG. 18, a region information selection button “TOHOKU” 911 is highlighted. At this time, when the user presses down a right arrow key, a left arrow key, an up arrow key, or a down arrow key (all not shown in the figure) of the user operation section 113, the user can move the highlighted button. Further, when the user pressed down a determination key (not shown in the figure) of the user operation section 113, a command assigned to the highlighted button is performed.

The above-mentioned operation is a technology employed also by a disk of the DVD-Video standards, but the command assigned to this button is expanded in the fifth embodiment to prepare a command for setting region selection condition information as user program selection condition information for the command.

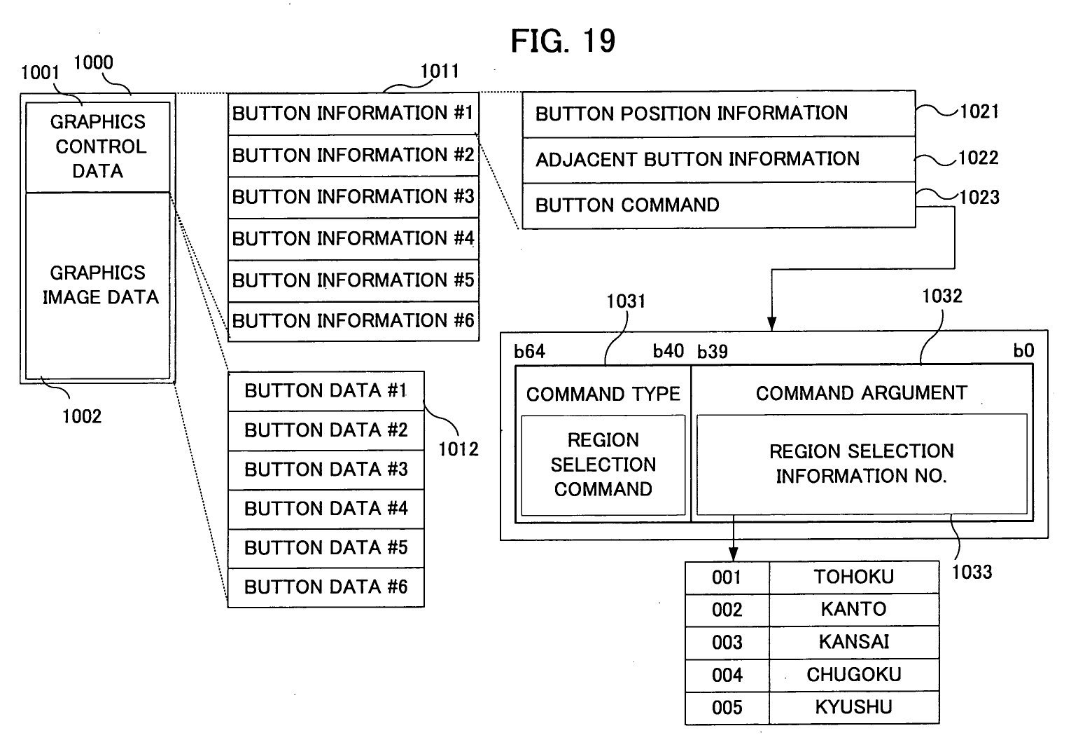

FIG. 19 is a diagram showing a logic data structure of the sub-image data information in the fifth embodiment. In FIG. 19, sub-image data information 1000 is a collection or integration of the sub-image packs 253 in the content data image 250 for a menu screen. The sub-image data information 1000 includes graphic control data 1001 and graphic image data 1002. The graphic image data 1002 is the information of the sub-image information (sub-picture image) 903 itself and includes the button data 1012 of the sub-image information depending on the number of buttons existing in the menu. Moreover, the graphic control data 1001 includes button information 1011 depending on the number of buttons existing in the menu. The button information 1011 and the button data 1012 are data corresponding to each other at a ratio of one to one. Since six buttons exist in the fifth embodiment, the description will be provided on the assumption that six pieces of button information 1011 and button data 1012 exist.

As shown in FIG. 19, each piece of button information 1011 includes button position information 1021, adjacent button information 1022, and a button command 1023. The button position information 1021 indicates coordinates and magnitude assigned as a button from the sub-picture image included in the graphic image data 1002. The adjacent button information 1022 indicates a button number to which highlight is moved in accordance with information inputted from the user operation section 113. In the button command 1023 is stored command information for defining the behavior of the recording medium playback apparatus 105 when the selection of a button is determined.

As shown in FIG. 19, the button command 1023 includes a command type 1031 and a command argument 1032. The command type 1031 indicates the basic type of a command and the command argument 1032 is handled as a modifier of the command type 1031. Also in the DVD-Video standards, the same technology is used and a “jump command”, a “set command”, and the like are generally used. For example, in the data structure of the “jump command”, a bit train showing the “jump command” is recorded on the command type 1031 and a “title number” is held in the command argument 1032. When such a button command 1023 is executed, the processing advances to the playback block of the title number held in the command argument 1032 to start the playback of this playback block 230.

In the fifth embodiment, a “region selection command” for specifying program selection condition information is held in the command type 1031 of the button command 1023 and a “region selection information number” is held in the command argument 1032.

In FIG. 19 is shown a code packing example in a case in which the bit length of the button command 1023 is assumed to be sixty-four bits. It is assumed that, for example, when a value of 1 is assigned to all zones of fourteen bits of from the 63rd bit to the 40th bit in the command type 1031, the command type is handled as a “region selection command”.

A “region selection information number” is recorded on the BCD unit or the like in the command argument 1032. By way of example of bit assignment, numerical information of from hundreds place to one place of the region selection information number is held for a zone of forty bits from the 39th bit to the 0th bit. In the fifth embodiment, as shown in FIG. 19, it is assumed that a value within a range from ‘001’ to ‘005’ is set.

In the fifth embodiment is shown an example in which the region selection information number is held as the command argument 1032 in the button command 1023. However, the region selection information number 1033 can also be held in a place independent of the data in the button command 1032 and also in this case, the same effect can be produced.

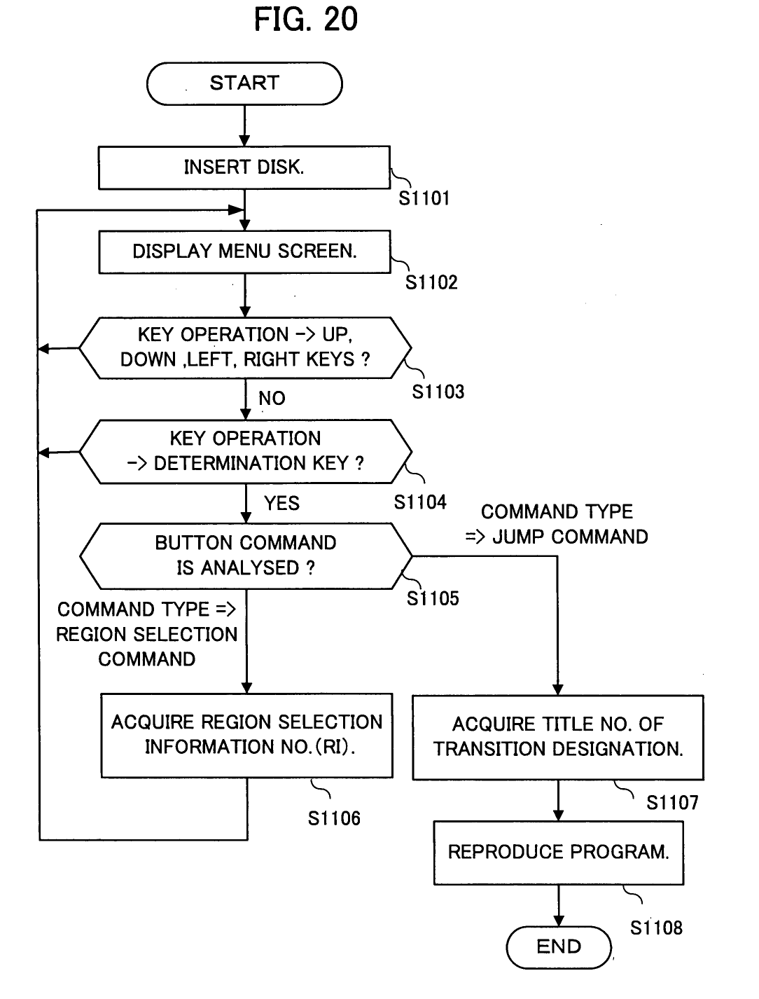

FIG. 20 is a flowchart showing the processing of setting region selection condition information in the fifth embodiment. A processing operation of setting region information will now be described with reference to FIG. 1, FIG. 17, FIG. 18, FIG. 19, and FIG. 20.

When the DVD-ROM disk 100E is inserted into the playback drive 110 (or when operation of calling a menu screen is performed after inserting a disk) (step S1101 in FIG. 20), the content data information 250 for a menu screen recorded on the DVD-ROM disk 100E is reproduced in accordance with a request of the system controller 112. When the content data information 250 for a menu screen is reproduced, the menu screen 901 is displayed on the display section 120 (step S1102 in FIG. 20). In the fifth embodiment, six buttons are prepared on the menu screen 901 and one of them is highlighted.

The user (viewer) can press down any one of the arrow keys (up, down, left, and right keys) in the respective directions of the user operation section 113 (step S1103 in FIG. 20) to move highlight. Even if the highlight is moved, the menu screen 901 is held continuously displayed on the display section 120.

Moreover, the viewer can determine the selection of the highlighted button by pressing down the determination key of the user operation section 113 (step S1104 in FIG. 20). When the selection of the button is determined, the system controller 112 acquires the information of the button command 1023 in the button information 1011 corresponding to the pressed button and analyzes the data of the button command 1023 (step S1105 in FIG. 20).

Next, when a bit train specifying the “region selection command” is assigned to the command type 1031 of the button command 1023, the system controller 112 determines that the button command 1023 is the button command 1023 for setting the region selection information and acquires a region selection information number (RI: Region Information) 1033 from the command argument 1032 of the button command 1023 (step S1106 in FIG. 20). It is assumed that a code number related to the button is set as the region selection information number 1033 set in the command argument 1032. That is, a value of ‘001’ showing the “TOHOKU” region is set as the command argument 1032 of the region information selection button “TOHOKU” 911 on the menu screen 901; a value of ‘002’ showing the “KANTO” region is set as the command argument 1032 of the region information selection button “KANTO” 912; and a value of ‘003’ showing the “KANSAI” region is set as the command argument 1032 of the region information selection button “KANSAI” 913.

Here will be specifically described processing in a case in which the region selection information number 1033 is held in a place different from the internal data of the button command 1032, for example, independently in the button information 1011. When the button is determined by the user operation section 113, first, irrespective of the command type 1031, the region selection information number 1033 in the button information 1011 is held in the region selection information storage 114 in the recording medium playback apparatus 105. Then, a command written in the button command 1023 is executed. At this time, for example, when a jump command to the playback block 230, to which the random playback is set, is assigned to the button command 1023, the playback block 230 is reproduced at the same time when the region setting parameter is set, whereby the same effect can be produced.

In the fifth embodiment, the description will be provided specifically on the assumption that the region information selection button “KANSAI” 913 on the menu screen 901 is selected and pressed down. When the region information selection button “KANSAI” 913 is pressed down (step S1104 in FIG. 20), the system controller 112 acquires a code number ‘003’ in the region selection information number 1033 from the command argument 1032. Then, the system controller 112 holds this code number in the region selection information storage 114 in the recording medium playback apparatus 105 and returns the processing to the menu screen 901. The region selection information storage 114, as shown in the figure, may be also an internal memory in the recording medium playback apparatus 105 or may be also the register of the system controller 112.

Thereafter, the button 916 for starting to reproduce a target program is pressed down on the menu screen 901 (step S1104 in FIG. 20). A bit train showing a “jump command” is stored in the command type 1031 of the button 916 for starting to reproduce a target program, and the system controller acquires a title number indicating the command argument 1032 (step S1107 in FIG. 20) and reproduces the playback block 230 of the title number (step S1108 in FIG. 20). By this operation, a target (program) of the playback block 230 to which random playback is set is reproduced.

The subsequent playback processing is the same as in the first embodiment. For example, the processing operation of reproducing the playback block 230 to which random playback is set is performed in the same mode as in the first embodiment. In the fifth embodiment, the same playback mode as in the first embodiment is not necessarily performed. For example, the playback type may include any one or more of normal sequential playback, shuffle playback, and random playback. Moreover, the playback type may include also pseudo-random playback guaranteeing number of playbacks, which will be described in the sixth embodiment or the seventh embodiment.

As described above, according to the fifth embodiment, the user can set the region selection information number by a simple operation such as operation of selecting a button while viewing a menu screen image. Moreover, the user is not required to set the region selection information number in advance manually to the recording medium playback apparatus 105, so it is possible to realize an improvement in operability and a reduction in load applied to the user.

### SIXTH EMBODIMENT

A portable recording medium 100F, a recording medium playback apparatus 106, and a recording medium playback method in the sixth embodiment will be described below. The sixth embodiment is different from the second embodiment in that, in addition to the shuffle playback and the random playback, a pseudo-random playback guaranteeing number of playbacks is added as a non-sequential playback type RT. The pseudo-random playback guaranteeing number of playbacks is a playback mode of reproducing programs non-sequentially, in which when programs are reproduced a predetermined number of times by the recording medium playback apparatus, the programs are reproduced non-sequentially in such a way that numbers of playbacks of the programs based on the occurrence frequency recorded on the portable recording medium are surely guaranteed. The portable recording medium 100F, the recording medium playback apparatus 106, and the recording medium playback method in the sixth embodiment are the same as the portable recording medium 100B, the recording medium playback apparatus 102, and the recording medium playback method in the second embodiment except that the sixth embodiment has the function of the pseudo-random playback guaranteeing number of playbacks.

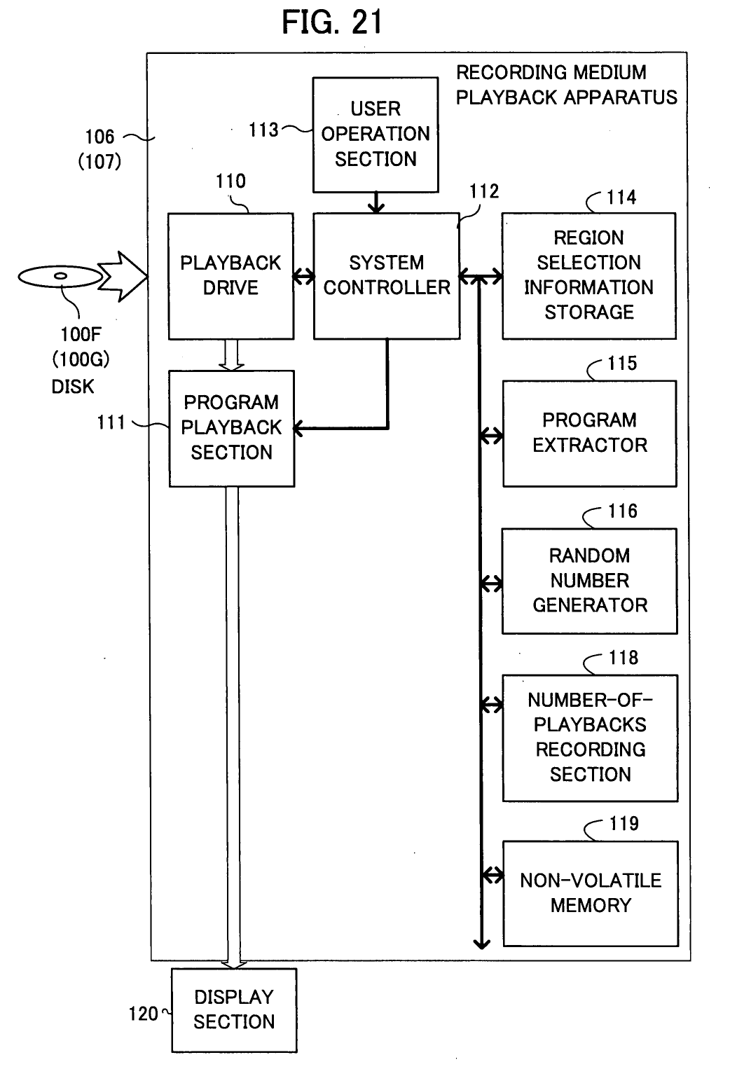

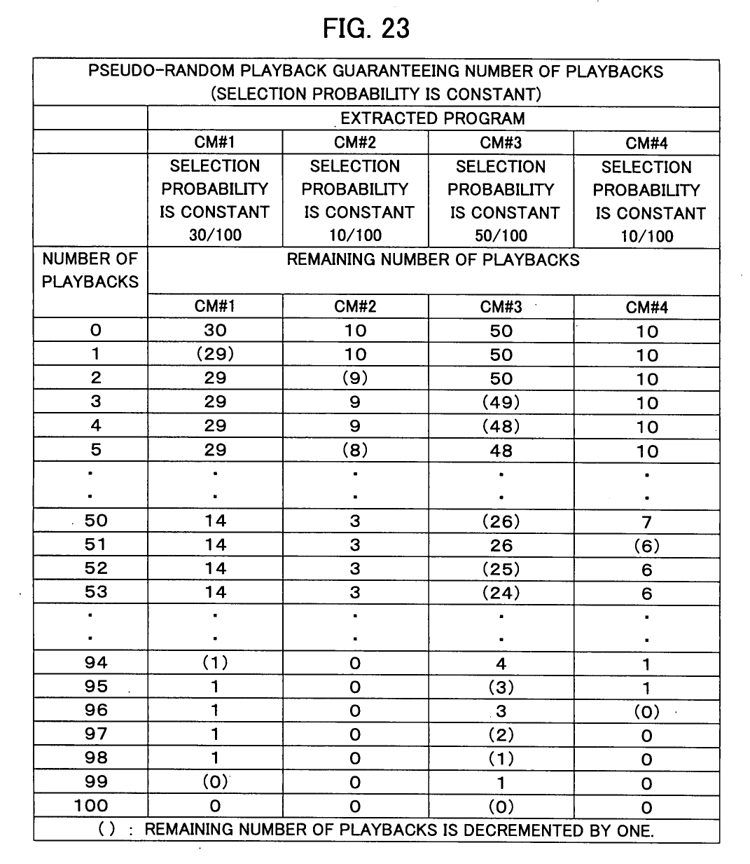

FIG. 21 is a block diagram schematically showing a configuration of the recording medium playback apparatus 106 in the sixth embodiment. In FIG. 21, constituent elements that are the same as or correspond to those in FIG. 1 are assigned the same reference numerals or symbols. As shown in FIG. 21, the recording medium playback apparatus 106 reproduces program information recorded on a DVD-ROM disk 100F as a portable recording medium. The recording medium playback apparatus 106 includes a playback drive 110 which reads information from the DVD-ROM disk 100F, a program playback section 111 which decompresses a coded compressed signal read from the DVD-ROM disk 100F to produce an analog image, a system controller 112 which controls the whole of the recording medium playback apparatus 106 in an integrated manner, and a user operation section 113 in which the user inputs data to the system controller 112. Moreover, the recording medium playback apparatus 106 includes a region selection information storage 114 which stores apparatus playback region information inputted from the user operation section 113, a program extractor 115 which extracts a program to be selected in non-sequential playback on the basis of apparatus playback region information of the region selection information storage 114 during the non-sequential playback, and a random number generator 116 which generates random numbers. The program extractor 115 selects a program to be reproduced next from a group of extracted programs in accordance with a random number generated by the random number generator 116. The program playback section 111 converts the selected program into analog image signals in accordance with a command from the system controller 112 and sends the analog image signals to a display section 120. Moreover, the recording medium playback apparatus 106 includes a number-of-playbacks recording section (for example, a DRAM) 118 which records the number of playbacks of each of the programs, and a memory (for example, a non-volatile memory) 119 which stores the remaining number of playbacks (the contents to be described later in FIG. 23). The zone of storing the number of playbacks and the remaining number of playbacks for each of the programs is not limited to the construction shown in the figure. Moreover, at the time of the pseudo-random playback guaranteeing number of playbacks, when an extracted program is reproduced a predetermined number of times, the programs are reproduced non-sequentially in such a way that the numbers of playbacks of programs based on the occurrence frequency parameter information are surely guaranteed.

In the sixth embodiment, the content index information 220B recorded on the DVD-ROM 100F has a program selection condition information table 302B containing the occurrence frequency parameter information for each playback unit (see FIG. 7). In the description of the sixth embodiment, FIG. 2 and FIG. 7 used for describing the second embodiment are also referred to.

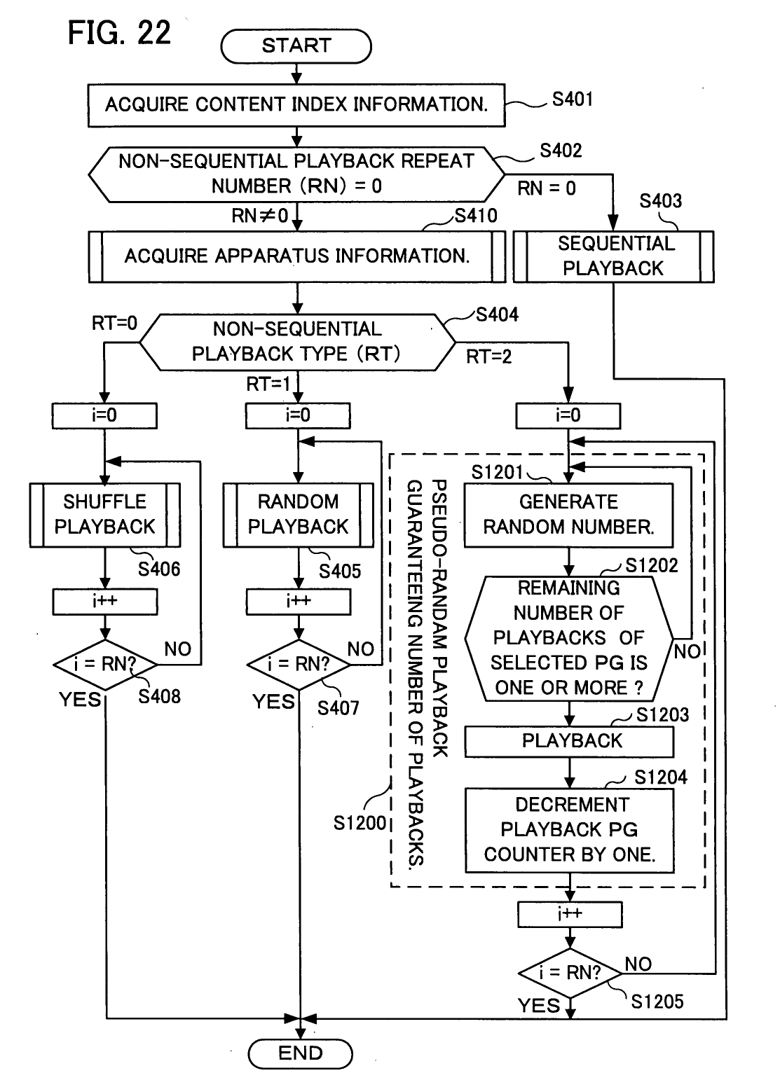

FIG. 22 is a flowchart showing operation of the recording medium playback apparatus 106 in the sixth embodiment. Moreover, FIG. 23 is a diagram showing operation at the time of the pseudo-random playback guaranteeing number of playbacks. In the sixth embodiment, it is assumed that an information zone of two bits is provided as the recording zone of the non-sequential playback type flag 300 and that any one of values of ‘0’, ‘1’, and ‘2’ is set in the recording zone. When the non-sequential playback type flag 300 is set to ‘1’, the disk is reproduced in the random playback mode (step S405 in FIG. 22); when the non-sequential playback type flag 300 is set to ‘0’, the disk is reproduced in the shuffle playback mode (step S406 in FIG. 22); and when the non-sequential playback type flag 300 is set to ‘2’, the disk is reproduced in the mode of pseudo-random playback guaranteeing number of playbacks (step S1200 in FIG. 22).

A case will be described below in which: as shown in FIG. 23, programs to be reproduced in the mode of pseudo-random playback guaranteeing number of playbacks (that is, programs extracted in step S410) are four commercial information programs CM#1, CM#2, CM#3, and CM#4; the occurrence frequency parameters recorded on the DVD-ROM disk 100F are 30, 10, 50, and 10 for the commercial information programs CM#1, CM#2, CM#3, and CM#4; and the number of repeats RN is 1. In the sixth embodiment, for example, when the playback of the programs is performed 100 times (=30+10+50+10), it is guaranteed that the numbers of playbacks of the commercial information programs CM#1, CM#2, CM#3, and CM#4 surely become 30, 10, 50, and 10. Moreover, in the sixth embodiment, the specified selection probabilities of 30/100, 10/100, 50/100, and 10/100 are used at the time of selecting the commercial information programs CM#1, CM#2, CM#3, and CM#4.

The random number generator 116 generates random numbers within the range of the total sum (that is, 100) of the occurrence frequency parameters (that is, 30, 10, 50, and 10) of the programs extracted by the program extractor 115. In the sixth embodiment, random numbers are generated within the range from 1 to 100; when a value within the range from 1 to 30 is generated as a random number, CM#1 is selected; when a value within the range from 31 to 40 is generated as a random number, CM#2 is selected; when a value within the range from 41 to 90 is generated as a random number, CM#3 is selected; and when a value within the range from 91 to 100 is generated as a random number, CM#4 is selected. By this method, the program corresponding to the random number, that is, any one of the commercial information programs CM#1, CM#2, CM#3, and CM#4 can be selected on the selection probabilities of 30/100, 10/100, 50/100, and 10/100.

An example shown in FIG. 23 will be described below. In the example shown in FIG. 23, when the extracted programs CM#1, CM#2, CM#3, and CM#4 are reproduced 100 times at the time of pseudo-random playback guaranteeing number of playbacks, the programs are reproduced non-sequentially in such a way that 30, 10, 50, and 10 times, which are the number of playbacks based on the occurrence frequency parameter information, are surely guaranteed.

As shown in FIG. 23, before starting playback (the number of playbacks is 0), the remaining numbers of playbacks of the programs CM#1, CM#2, CM#3, and CM#4 are 30, 10, 50, and 10, respectively.

Next, the first playback is performed. In the first playback, first, a program is selected. The probabilities that the programs are selected (selection probabilities) are 30/100, 10/100, 50/100, and 10/100 for the programs CM#1, CM#2, CM#3, and CM#4, respectively (step S1201 in FIG. 22). Here, CM#1 is selected and it is determined whether or not the remaining number of playbacks of CM#1 is one or more (step S1200 in FIG. 22). Since the remaining number of playbacks of CM#1 is 30, the selected program CM#1 is reproduced (step S1203 in FIG. 22) and then a counter value indicating the remaining number of playbacks of the program CM#1 that has been reproduced is decremented by 1, thereby being changed from 30 to 29. As a result, the remaining numbers of playbacks of the programs CM#1, CM#2, CM#3, and CM#4 become 29, 10, 50, and 10, respectively.

Next, the second playback is performed. In the second playback, first, a program is selected. The probabilities that the programs are selected (selection probabilities) are not changed, so the probabilities are 30/100, 10/100, 50/100, and 10/100 for the programs CM#1, CM#2, CM#3, and CM#4, respectively (step S1201 in FIG. 22). Here, CM#2 is selected and it is determined whether or not the remaining number of playbacks of CM#2 is one or more (step S1202 in FIG. 22). Since the remaining number of playbacks of CM#2 is 10, the selected program CM#2 is reproduced (step S1203 in FIG. 22) and then a counter value indicating the remaining number of playbacks of the program CM#2 that has been reproduced is decremented by 1, thereby being changed from 10 to 9. As a result, the remaining numbers of playbacks of the programs CM#1, CM#2, CM#3, and CM#4 become 29, 9, 50, and 10, respectively.

Subsequently, the same program selection processing and playback processing are repeatedly performed. For example, the 95th playback will be described below. In the 95th playback, first, a program is selected. The probabilities that the programs are selected (selection probabilities) are not changed, so the probabilities are 30/100, 10/100, 50/100, and 10/100 for the programs CM#1, CM#2, CM#3, and CM#4, respectively (step S1201 in FIG. 22). If it is assumed that the program CM#2 is selected, it is determined whether or not the remaining number of playbacks of CM#2 is one or more (step S1202 in FIG. 22). Since the remaining number of playbacks of CM#2 is zero, the selected program CM#2 is not reproduced but a program is again selected (step S1201 in FIG. 22). If it is assumed that the program CM#3 is selected, it is determined whether or not the remaining number of playbacks of CM#3 is one or more (step S1202 in FIG. 22). Since the remaining number of playbacks of CM#3 is 4, the selected program CM#3 is reproduced (step S1203 in FIG. 22) and then a counter value indicating the remaining number of playbacks of the program CM#3 that has been reproduced is decremented by 1, thereby being changed from 4 to 3. As a result, the remaining numbers of playbacks of the programs CM#1, CM#2, CM#3, and CM#4 become 1, 0, 3, and 1, respectively.

Subsequently, the same program selection processing and playback processing are repeatedly performed until all of the remaining numbers of playbacks of the programs CM#1, CM#2, CM#3, and CM#4 become zero. In this regard, there is a case where the disk 100F is taken out of the recording medium playback apparatus 106 during playback. In this case, by recording the remaining numbers of playbacks shown in FIG. 23 together with the disk specified information, for example, in the memory 119 of the recording medium playback apparatus 106 or the disk itself (when the disk is a rewritable disk), even when the playback of the disk is restarted next, the predetermined numbers of playbacks can be guaranteed.

As described above, according to the sixth embodiment, a plurality of programs can be extracted from the DVD-ROM disk 100F in accordance with the user-definable program selection condition information of the recording medium playback apparatus 106 and the program selection condition information of the DVD-ROM disk 100F, and the extracted programs can be reproduced non-sequentially. For this reason, it is possible to divide content data into categories and to share the data in the DVD-ROM disk 100F, and hence to dramatically increase the rate of use of the data in DVD-ROM disk 100F. Moreover, according to the sixth embodiment, the content supplier can freely and easily set the rate of occurrence of a program that the supplier wants to urge the user to view even at the time of random playback by utilizing the program selection condition field 304B related to the user-definable program selection condition information held in the recording medium playback apparatus 106. When the content supplier manufactures a random playback disk designed for CM contents, this function makes it possible for the supplier to easily urge the user to select a program at a rate depending on a sponsor charge.

In this regard, the constructions of the third, fourth, and fifth embodiments may be combined with the portable recording medium 100F, the recording medium playback apparatus 106, and the recording medium playback method in the sixth embodiment.

Moreover, in the above description has been described a case in which the number of types of non-sequential playback is three. However, the types of non-sequential playback may be two or less types including the pseudo-random playback guaranteeing number of playbacks in the sixth embodiment. Further, the other types may be added to the non-sequential playback types to increase the number of types of non-sequential playback to four or more.

### SEVENTH EMBODIMENT

A portable recording medium 100G, a recording medium playback apparatus 107, and a recording medium playback method in the seventh embodiment will be described below. The medium, apparatus, and method in the seventh embodiment are different from the portable recording medium 100F, the recording medium playback apparatus 106, and the recording medium playback method in the sixth embodiment in that the selection probabilities used in the pseudo-random playback guaranteeing number of playbacks are changed. The seventh embodiment is the same as the sixth embodiment except for this point.

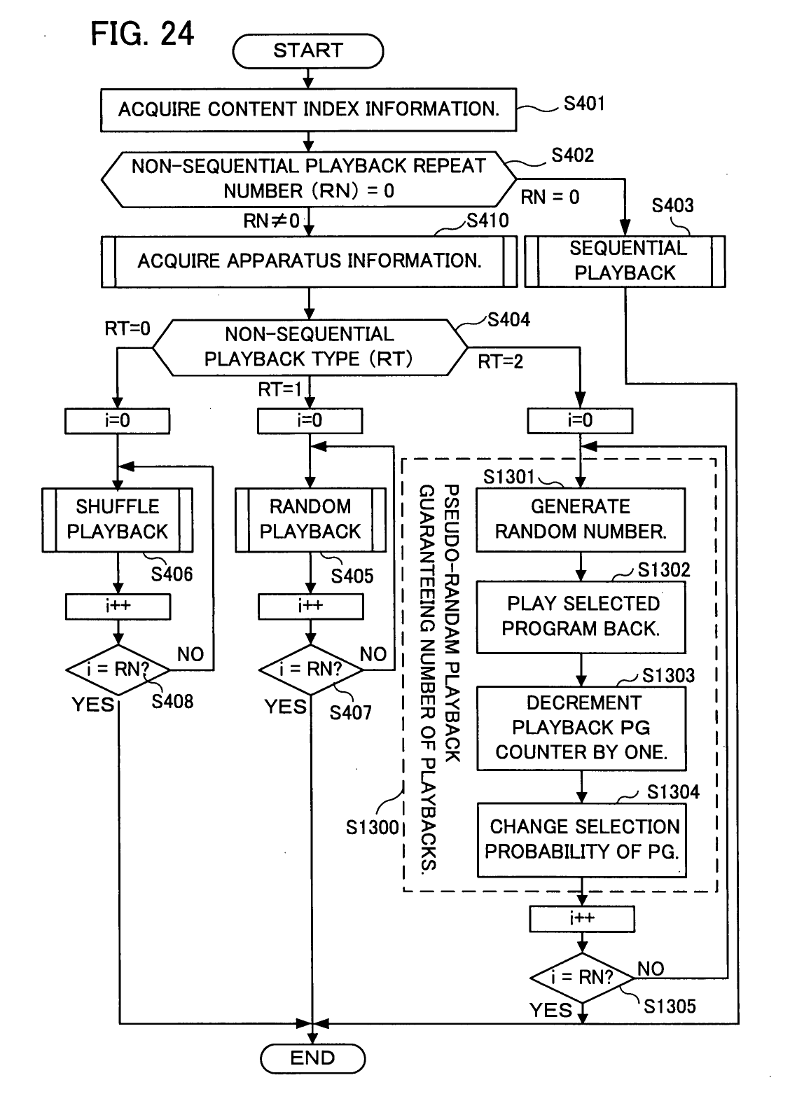

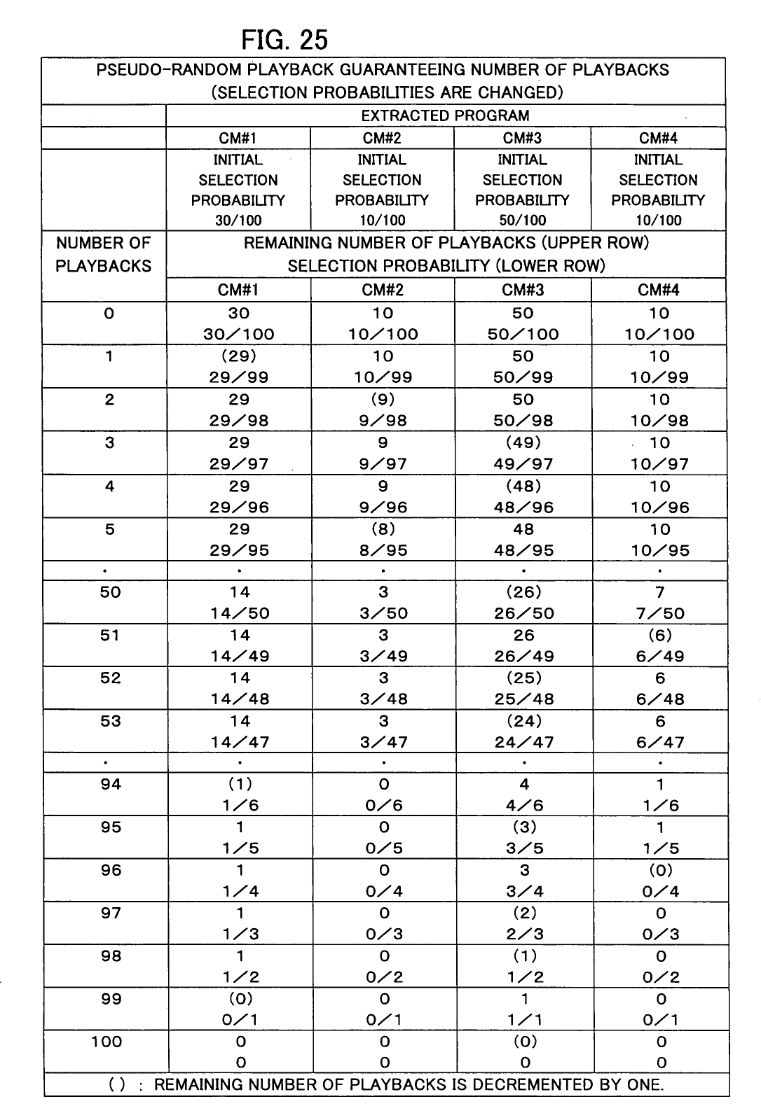

FIG. 24 is a flowchart showing operation of pseudo-random playback guaranteeing number of playbacks in the seventh embodiment in a case where a selection probability is changed. Moreover, FIG. 25 is a diagram of pseudo-random playback guaranteeing number of playbacks in the seventh embodiment in a case where a selection probability is changed. In the DVD-ROM disk 100G of the seventh embodiment, it is assumed that an information zone of two bits is provided as the recording zone of the non-sequential playback type flag 300, and any one of values of ‘0’, ‘1’, and ‘2’ is set in the recording zone. When the non-sequential playback type flag 300 is set to ‘1’, the disk is reproduced in the mode of random playback (step S405 in FIG. 24); when the non-sequential playback type flag 300 is set to ‘0’, the disk is reproduced in the shuffle playback mode (step S406 in FIG. 24); and when the non-sequential playback type flag 300 is set to ‘2’, the disk is reproduced in the mode of pseudo-random playback guaranteeing number of playbacks (step S1300 in FIG. 24).

A case will be described below in which: as shown in FIG. 25, programs to be reproduced in the mode of the pseudo-random playback guaranteeing number of playbacks are four commercial information programs CM#1, CM#2, CM#3, and CM#4; the occurrence frequency parameters recorded on the portable recording medium are 30, 10, 50, and 10 for the commercial information programs CM#1, CM#2, CM#3, and CM#4; and the number of repeats RN is 1. In the seventh embodiment, for example, when the playback of the program is performed 100 times (=30+10+50+10), it is guaranteed that the numbers of playbacks of the commercial information programs CM#1, CM#2, CM#3, and CM#4 surely become 30, 10, 50, and 10. Moreover, in the sixth embodiment, the selection probabilities of 30/100, 10/100, 50/100, and 10/100 are used at the time of selecting the commercial information programs CM#1, CM#2, CM#3, and CM#4. However, in the seventh embodiment, the selection probabilities are changed in accordance with the remaining number of playbacks of each program.

An example shown in FIG. 25 will be described below. In the example shown in FIG. 25, when the extracted programs CM#1, CM#2, CM#3, and CM#4 are reproduced 100 times at the time of the pseudo-random playback guaranteeing number of playbacks, the programs are reproduced non-sequentially in such a way that 30, 10, 50, and 10 times, which are the number of playbacks based on the occurrence frequency parameter information, are surely guaranteed.

At the time of the first program selection, the random number generator 116 generates random numbers within the range of the total sum (that is, 100) of the remaining numbers of playbacks (that is, 30, 10, 50, and 10) of the programs extracted by the program extractor 115. At this time, random numbers are generated within the range from 1 to 100; when a value within the range from 1 to 30 is generated as a random number, the program CM#1 is selected; when a value within the range from 31 to 40 is generated as a random number, the program CM#2 is selected; when a value within the range from 41 to 90 is generated as a random number, the program CM#3 is selected; and when a value within the range from 91 to 100 is generated as a random number, the program CM#4 is selected.

Moreover, when the first reproduced program is CM#1, at the time of the second program selection, the random number generator 116 generates random numbers within the range of the total sum (that is, 99) of the remaining numbers of playbacks (that is, 29, 10, 50, and 10) of the programs extracted by the program extractor 115. At this time, random numbers are generated within the range from 1 to 99; when a value within the range from 1 to 29 is generated as a random number, the program CM#1 is selected; when a value within the range from 30 to 39 is generated as a random number, the program CM#2 is selected; when a value within the range from 40 to 89 is generated as a random number, the program CM#3 is selected; and when a value within the range from 90 to 99 is generated as a random number, the program CM#4 is selected.

Thereafter, similarly, as shown in FIG. 25, the selection probabilities of the programs are changed in accordance with the total sum of the remaining numbers of playbacks of the respective programs and the remaining numbers of playbacks of the respective programs.

The pseudo-random playback guaranteeing number of playbacks shown in FIG. 25 is executed while the selection probabilities of the programs are changed in the following manner. As shown in FIG. 25, before starting playback (the number of playbacks is zero), the remaining numbers of playbacks of the programs CM#1, CM#2, CM#3, and CM#4 are 30, 10, 50, and 10.

Next, the first playback is performed. In the first playback, a program is selected. The probabilities that the programs are selected (selection probabilities) are 30/100, 10/100, 50/100, and 10/100 for the programs CM#1, CM#2, CM#3, and CM#4, respectively (step S1301 in FIG. 24). The program CM#1 is selected, and then CM#1 is reproduced (step S1302 in FIG. 24) and a counter value indicating the remaining number of playbacks of the program CM#1 that has been reproduced is decremented by 1 (step S1303 in FIG. 24), thereby being changed from 30 to 29. As a result, the remaining numbers of playbacks of the programs CM#1, CM#2, CM#3, and CM#4 become 29, 10, 50, and 10 times, respectively. Next, the selection probabilities used at the time of selecting the next program are changed (step S1304 in FIG. 24). The selection probability of the program CM#1 is changed from 30/100 to 29/99. As a result, the selection probabilities become 29/99, 10/99, 50/99, and 10/99 for the programs CM#1, CM#2, CM#3, and CM#4, respectively.

Next, the second playback is performed. In the second playback, first, a program is selected. The probabilities that the programs are selected (selection probabilities) are changed values, that is, 29/99, 10/99, 50/99, and 10/99 for the programs CM#1, CM#2, CM#3, and CM#4, respectively (step S1301 in FIG. 24). Since the program CM#2 is selected, CM#2 is reproduced (step S1302 in FIG. 24) and then a counter value indicating the remaining number of playbacks of the program CM#2 that has been reproduced is decremented by 1 (step S1303 in FIG. 24), thereby being changed from 10 to 9. As a result, the remaining numbers of playbacks of the programs CM#1, CM#2, CM#3, and CM#4 become 29, 9, 50, and 10 times, respectively. Next, the selection probabilities used at the time of selecting the next program are changed (step S1304 in FIG. 24). The selection probability of the program CM#2 is changed from 10/99 to 9/98. As a result, the selection probabilities become 29/98, 9/98, 50/98, and 10/98 for the programs CM#1, CM#2, CM#3, and CM#4, respectively.

Subsequently, the same program selection processing and playback processing are repeatedly performed. For example, the 95th playback will be described below. In the 95th playback, first, a program is selected. The probabilities that the programs are selected (selection probabilities) are changed values, that is, 1/6, 0/6, 4/6, and 1/6 for the programs CM#1, CM#2, CM#3, and CM#4, respectively (step S1301 in FIG. 24). The selection probability of the program CM#2 is 0/6, that is, zero, so that the program CM#2 is not selected. Thus, in the seventh embodiment, it is not necessary to determine whether or not the remaining number of playbacks is one or more, as is the case with the processing of step S1202 in the sixth embodiment. If it is assumed that the program CM#3 is selected, CM#3 is reproduced (step S1302 in FIG. 24) and then a counter value indicating the remaining number of playbacks of the program CM#3 that has been reproduced is decremented by 1 (step S1303 in FIG. 24), thereby being changed from 4 to 3. As a result, the remaining numbers of playbacks of the programs CM#1, CM#2, CM#3, and CM#4 become 1, 0, 3, and 1, respectively. Next, the selection probabilities used at the time of selecting the next program are changed (step S1304 in FIG. 24). The selection probability of the program CM#3 is changed from 4/6 to 3/5. As a result, the selection probabilities become 1/5, 0/5, 3/5, and 1/5 for the programs CM#1, CM#2, CM#3, and CM#4, respectively.

Subsequently, the same program selection processing and playback processing are repeatedly performed until all of the remaining numbers of playbacks of the programs CM#1, CM#2, CM#3, and CM#4 become zero.

As described above, according to the seventh embodiment, the same effect as the sixth embodiment can be produced. Moreover, according to the seventh embodiment, the selection probabilities are decreased in accordance with the remaining numbers of playbacks of the programs, so the rate of decrease in the remaining numbers of playbacks of the programs can be made uniform.

In this regard, the constructions or processes of the first to sixth embodiments may be combined with the portable recording medium 100G, the recording medium playback apparatus 107, and the recording medium playback method in the seventh embodiment.

Moreover, in the above description has been described a case in which the number of types of non-sequential playback are three. However, the types of non-sequential playback may be two or less types including the pseudo-random playback guaranteeing number of playbacks in the seventh embodiment. Further, other types may be added to the types of non-sequential playback to increase the number of types of non-sequential playback to four or more.

What is claimed is:

1. A portable recording medium containing:
coded compressed content data information; and
content index information;
the content data information including a plurality of programs, each of the programs being treated as a unit of playback;
the content index information including
a flag indicating presence or absence and type of non-sequential playback of the programs in the content data information,
information on number of repeats of the programs during the non-sequential playback, and
a program selection condition information table;
wherein the program selection condition information table includes playback permission/prohibition information indicating whether or not each of the programs is permitted to be reproduced during the non-sequential playback in accordance with user-definable program selection condition information held by a recording medium playback apparatus.

2. The portable recording medium according to claim 1,
wherein the program selection condition information table further includes occurrence frequency parameter information of each of the programs during the non-sequential playback.

3. A portable recording medium containing:
coded compressed content data information;
content index information; and
menu screen content data information;
the content data information including a plurality of programs, each of the programs being treated as a unit of playback;
the content index information including
a flag indicating presence or absence and type of non-sequential playback of the programs in the content data information,
information on number of repeats of the programs during the non-sequential playback, and
a program selection condition information table;
wherein the menu screen content data information includes menu screen information which makes it possible to select an effective item of program selection condition information from the program selection condition information table by use of a menu screen;
wherein the program selection condition information table includes playback permission/prohibition information indicating whether or not each of the programs is permitted to be reproduced during the non-sequential playback in accordance with user-definable program selection condition information assigned to a button displayed based on the menu screen information during the non-sequential playback.

4. The portable recording medium according to claim 3,
wherein the program selection condition information table further includes occurrence frequency parameter information of each of the programs during the non-sequential playback.

5. A portable recording medium containing:
coded compressed content data information; and
content index information;
the content data information including a plurality of programs, each of the programs being treated as a unit of playback;
the content index information including
a flag indicating presence or absence and type of non-sequential playback of the programs in the content data information,
information on number of repeats of the programs during the non-sequential playback, and
an expiration date information table;
wherein the expiration date information table includes viewing valid period information of each of the programs.

6. The portable recording medium according to claim 5,
wherein the content index information further includes a program selection condition information table,
the program selection condition information table including playback permission/prohibition information indicating whether or not each of the programs is permitted to be reproduced during the non-sequential playback in accordance with user-definable program selection condition information held by a recording medium playback apparatus during the non-sequential playback.

7. The portable recording medium according to claim 5, further containing menu screen content data information;
the program selection condition information table including playback permission/prohibition information indicating whether or not each of the programs is permitted to be reproduced during the non-sequential playback in accordance with each program selection condition information during the non-sequential playback;
the menu screen content data information including menu screen information which makes it possible to select an effective item of program selection condition information from the program selection condition information table by use of a menu screen.

8. The portable recording medium according to claim 6,
wherein the program selection condition information table further includes occurrence frequency parameter information of each of the programs during the non-sequential playback.

9. A portable recording medium containing:
coded compressed content data information; and
content index information;
the content data information including a plurality of programs, each of the programs being treated as a unit of playback;
the content index information including
a flag indicating presence or absence and type of non-sequential playback of the programs in the content data information,
information on number of repeats of the programs during the non-sequential playback, and
a program selection condition information table;
the program selection condition information table including occurrence frequency parameter information of each of the programs during the non-sequential playback;
wherein the non-sequential playback includes a pseudo-random playback guaranteeing number of playbacks, in which when the programs are reproduced a predetermined number of times by a recording medium playback apparatus, the programs are reproduced non-sequentially in such a way that number of playbacks based on the occurrence frequency parameter information is guaranteed.

10. The portable recording medium according to claim 9,
wherein in the pseudo-random playback guaranteeing number of playbacks,
a selection probability that any one of the programs is selected is a value based on the guaranteed number of playbacks, and
the selection probability is held constant until program playbacks of the guaranteed number of playbacks are finished.

11. The portable recording medium according to claim 9,
wherein in the pseudo-random playback guaranteeing number of playbacks,
a selection probability that any one of the programs is selected is a value based on the guaranteed number of playbacks in a first program playback, and
thereafter until program playbacks of the guaranteed number of playbacks are finished, a selection probability of each of the programs is changed in such a way that the selection probability of each of the programs becomes a value based on remaining number of playbacks of each of the programs that is obtained by subtracting a number of times that each of the programs has been actually reproduced from the guaranteed number of playbacks of each of the programs.

12. The portable recording medium according to claim 9,
wherein the program selection condition information table includes playback permission/prohibition information indicating whether or not each of the programs is permitted to be reproduced during the non-sequential playback in accordance with user-definable program selection condition information held by a recording medium playback apparatus during the non-sequential playback.

13. The portable recording medium according to claim 9, further containing menu screen content data information;
the program selection condition information table including playback permission/prohibition information indicating whether or not each of the programs is permitted to be reproduced during the non-sequential playback in accordance with user-definable program selection condition information held by a recording medium playback apparatus during the non-sequential playback;
the menu screen content data information including menu screen information which makes it possible to select an effective item of program selection condition information from the program selection condition information table by use of a menu screen.

14. The portable recording medium according to claim 9,
wherein the content index information further includes an expiration date information table,
the expiration date information table including viewing valid period information of each of the programs.

15. A recording medium playback apparatus capable of reproducing the portable recording medium of claim 1, the apparatus comprising:
a user-defined information recording section which holds user-definable program selection condition information;
a program extractor which, during the non-sequential playback, extracts an available program from the portable recording medium in accordance with a program selection condition information table read from the portable recording medium and the user-defined program selection condition information; and
a program playback section which, during the non-sequential playback, non-sequentially selects a program to be reproduced from the programs that have been extracted by the program extractor from the portable recording medium, and then reads and reproduces the selected program to be reproduced.

16. A recording medium playback apparatus capable of reproducing the portable recording medium of claim 2, the apparatus comprising:
a user-defined information recording section which holds user-definable program selection condition information;
a program extractor which, during the non-sequential playback, extracts an available program and occurrence frequency parameter information from the portable recording medium in accordance with a program selection condition information table read from the portable recording medium and the user-definable program selection condition information; and
a program playback section which, during the non-sequential playback, non-sequentially selects a program to be reproduced from the programs that have been extracted by the program extractor from the portable recording medium, at a probability based on the occurrence frequency parameter information, and then reads and reproduces the selected program to be reproduced.

17. A recording medium playback apparatus capable of reproducing the portable recording medium of claim 3, the apparatus comprising:
a program extractor which, during the non-sequential playback, extracts an available program from the portable recording medium in accordance with a program selection condition information table read from the portable recording medium and user-definable program selection condition information assigned to a button displayed based on menu screen information; and
a program playback section which, during the non-sequential playback, selects a program to be reproduced from the programs that have been extracted by the program extractor from the portable recording medium, and then reads and reproduces the selected program to be reproduced.

18. A recording medium playback apparatus capable of reproducing the portable recording medium of claim 4, the apparatus comprising:
a program extractor which, during the non-sequential playback, extracts an available program from the portable recording medium in accordance with a program selection condition information table read from the portable recording medium and information selected by use of the menu screen content data information; and
a program playback section which, during the non-sequential playback, non-sequentially selects a program to be reproduced from the programs that have been extracted by the program extractor from the portable recording medium, at a probability based on occurrence frequency parameter information, and then reads and reproduces the selected program to be reproduced.

19. A recording medium playback apparatus capable of reproducing the portable recording medium of claim 5, the apparatus comprising:
a time information acquisition section which holds present time information;
a program extractor which, during the non-sequential playback, extracts an available program from the portable recording medium in accordance with an expiration date information table read from the portable recording medium and the present time information; and
a program playback section which, during the non-sequential playback, non-sequentially selects a program to be reproduced from the programs that have been extracted by the program extractor from the portable recording medium, and then reads and reproduces the selected program to be reproduced.

20. A recording medium playback apparatus capable of reproducing the portable recording medium of claim 6, the apparatus comprising:
a user-defined information recording section which holds user-definable program selection condition information;
a time information acquisition section which holds present time information;
a program extractor which, during the non-sequential playback, extracts an available program from the portable recording medium in accordance with an expiration date information table read from the portable recording medium and the present time information, program selection condition information read from the portable recording medium, and the user-definable program selection condition information; and
a program playback section which, during the non-sequential playback, non-sequentially selects a program to be reproduced from the programs that have been extracted by the program extractor from the portable recording medium, and then reads and reproduces the selected program to be reproduced.

21. A recording medium playback apparatus capable of reproducing the portable recording medium of claim 7, the apparatus comprising:
a time information acquisition section which holds present time information;
a program extractor which, during the non-sequential playback, extracts an available program from the portable recording medium in accordance with an expiration date information table read from the portable recording medium and the present time information, program selection condition information read from the portable recording medium, and the user-definable program selection condition information, which is assigned to a button displayed based on menu screen information; and
a program playback section which, during the non-sequential playback, selects a program to be reproduced from the programs that have been extracted by the program extractor from the portable recording medium, and then reads and reproduces the selected program to be reproduced.

22. A recording medium playback apparatus capable of reproducing the portable recording medium of claim 8, the apparatus comprising:
a user-defined information recording section which holds user-definable program selection condition information;
a time information acquisition section which holds present time information;
a program extractor which, during the non-sequential playback, extracts an available program from the portable recording medium in accordance with an expiration date information table read from the portable recording medium and the present time information, program selection condition information read from the portable recording medium, and the user-definable program selection condition information; and
a program playback section which, during the non-sequential playback, non-sequentially selects a program to be reproduced at a probability based on occurrence frequency parameter information from the programs that have been extracted by the program extractor from the portable recording medium, and then reads and reproduces the selected program to be reproduced.

23. A recording medium playback apparatus capable of reproducing the portable recording medium of claim 9, the apparatus comprising:
a program extractor which extracts an available program from the portable recording medium;
a number-of-playbacks recording section which, during pseudo-random playback guaranteeing number of playbacks, records number of playbacks of each of the programs; and
a program playback section which, during pseudo-random playback guaranteeing number of playbacks, non-sequentially reproduces the extracted program in such a way that when the extracted program is reproduced a predetermined number of playbacks, number of playbacks based on occurrence frequency parameter information is guaranteed.

24. A recording medium playback apparatus capable of reproducing the portable recording medium of claim 10, the apparatus comprising:
a program extractor which extracts an available program from the portable recording medium;
a number-of-playbacks recording section which, during pseudo-random playback guaranteeing number of playbacks, records number of playbacks of each of the programs; and
a program playback section which, during pseudo-random playback guaranteeing number of playbacks, non-sequentially reproduces the extracted program in such a way that when the extracted program is reproduced a predetermined number of playbacks, number of playbacks based on occurrence frequency parameter information is guaranteed and that a selection probability that a certain program is selected becomes a specified value based on the guaranteed number of playbacks.

25. A recording medium playback apparatus capable of reproducing the portable recording medium of claim 11, the apparatus comprising:
a program extractor which extracts an available program from the portable recording medium;
a number-of-playbacks recording section which, during pseudo-random playback guaranteeing number of playbacks, records number of playbacks of each of the programs; and
a program playback section which, during pseudo-random playback guaranteeing number of playbacks, non-sequentially reproduces the extracted program while changing a selection probability of each of the programs, in such a way that:
when the extracted program is reproduced a predetermined number of playbacks, number of playbacks based on occurrence frequency parameter information is guaranteed; in a first program playback, a selection probability that any one of the programs is selected is a value based on the guaranteed number of playbacks; and thereafter until program playbacks of the guaranteed number of playbacks are finished, a probability of each of the programs becomes a value based on remaining number of playbacks of each of the programs that is obtained by subtracting a number of times that each of the programs has been actually reproduced from the guaranteed number of playbacks.

26. A recording medium playback apparatus capable of reproducing the portable recording medium of claim 12, the apparatus comprising:
a user-defined information recording section which holds user-definable program selection condition information;
a program extractor which, during the non-sequential playback, extracts an available program from the portable recording medium in accordance with program selection condition information table read from the portable recording medium and the user-definable program selection condition information;
a number-of-playbacks recording section which, during pseudo-random playback guaranteeing number of playbacks, records number of playbacks of each of the programs; and
a program playback section which, during pseudo-random playback guaranteeing number of playbacks, non-sequentially reproduces the extracted program in such a way that when the extracted program is reproduced a predetermined number of playbacks, number of playbacks based on occurrence frequency parameter information is guaranteed.

27. A recording medium playback apparatus capable of reproducing the portable recording medium of claim 13, the apparatus comprising:
a program extractor which, during the non-sequential playback, extracts an available program from the portable recording medium in accordance with program selection condition information table read from the portable recording medium and information selected by use of the menu screen content data information;
a number-of-playbacks recording section which, during pseudo-random playback guaranteeing number of playbacks, records number of playbacks of each of the programs; and
a program playback section which, during pseudo-random playback guaranteeing number of playbacks, non-sequentially reproduces the extracted program in such a way that when the extracted program is reproduced a predetermined number of playbacks, number of playbacks based on occurrence frequency parameter information is guaranteed.

28. A recording medium playback apparatus capable of reproducing the portable recording medium of claim 14, the apparatus comprising:
a time information acquisition section which holds present time information;
a program extractor which, during the non-sequential playback, extracts an available program from the portable recording medium in accordance with expiration date information read from the portable recording medium and the present time information;
a number-of-playbacks recording section which, during pseudo-random playback guaranteeing number of playbacks, records number of playbacks of each of the programs; and
a program playback section which, during pseudo-random playback guaranteeing number of playbacks, non-sequentially reproduces the extracted program in such a way that when the extracted program is reproduced a predetermined number of playbacks, number of playbacks based on occurrence frequency parameter information is guaranteed.

29. A recording medium playback method for reproducing the portable recording medium of claim 1, the method comprising the steps of:
during the non-sequential playback, extracting an available program from the portable recording medium in accordance with a program selection condition information table read from the portable recording medium and user-defined program selection condition information; and
during the non-sequential playback, selecting a program to be reproduced non-sequentially from the programs that have been extracted from the portable recording medium, and then reading and reproducing the selected program to be reproduced.

30. A recording medium playback method for reproducing the portable recording medium of claim 2, the method comprising the steps of:
during the non-sequential playback, extracting an available program and occurrence frequency parameter information from the portable recording medium in accordance with a program selection condition information table read from the portable recording medium and user-definable program selection condition information; and
during the non-sequential playback, selecting a program to be reproduced at a probability based on the occurrence frequency parameter information from the programs that have been extracted from the portable recording medium non-sequentially, and then reading and reproducing the selected program to be reproduced.

31. A recording medium playback method for reproducing the portable recording medium of claim 3, the method comprising the steps of:
during the non-sequential playback, extracting an available program from the portable recording medium in accordance with a program selection condition information table read from the portable recording medium and user-definable program selection condition information, which is assigned to a button displayed on menu screen information; and
during the non-sequential playback, selecting a program to be reproduced from the programs that have been extracted from the portable recording medium, and then reading and reproducing the selected program to be reproduced.

32. A recording medium playback method for reproducing the portable recording medium of claim 4, the method comprising the steps of:
during the non-sequential playback, extracting an available program from the portable recording medium in accordance with a program selection condition information table read from the portable recording medium and information, which is selected by use of the menu screen content data information; and
during the non-sequential playback, selecting a program to be reproduced non-sequentially at a probability based on occurrence frequency parameter information from the programs that have been extracted from the portable recording medium, and then reading and reproducing the selected program to be reproduced.

33. A recording medium playback method for reproducing the portable recording medium of claim 5, the method comprising the steps of:
during the non-sequential playback, extracting an available program from the portable recording medium in accordance with an expiration date information table read from the portable recording medium and the present time information; and
during the non-sequential playback, selecting a program to be reproduced non-sequentially from programs which are extracted from the portable recording medium, and then reading and reproducing the selected program to be reproduced.

34. A recording medium playback method for reproducing the portable recording medium of claim 6, the method comprising the steps of:
holding user-definable program selection condition information;
during the non-sequential playback, extracting an available program from the portable recording medium in accordance with an expiration date information table read from the portable recording medium and the present time information, program selection condition information read from the portable recording medium, and the user-definable program selection condition information; and
during the non-sequential playback, selecting a program to be reproduced non-sequentially from the programs that have been extracted from the portable recording medium, and then reading and reproducing the selected program to be reproduced.

35. A recording medium playback method for reproducing the portable recording medium of claim 7, the method comprising the steps of:
holding present time information;
during the non-sequential playback, extracting an available program from the portable recording medium in accordance with an expiration date information table read from the portable recording medium and the present time information, program selection condition information read from the portable recording medium, and user-definable program selection condition information, which is assigned to a button displayed based on menu screen information; and
during the non-sequential playback, selecting a program to be reproduced from programs extracted by the program extractor from the portable recording medium, and then reading and reproducing the selected program to be reproduced.

36. A recording medium playback method for reproducing the portable recording medium of claim 8, the method comprising the steps of:
holding present time information;
during the non-sequential playback, extracting an available program from the portable recording medium in accordance with an expiration date information table read from the portable recording medium and the present time information, program selection condition information read from the portable recording medium, and the user-definable program selection condition information; and
during the non-sequential playback, selecting a program to be reproduced non-sequentially at a probability based on occurrence frequency parameter information from the programs that have been extracted by the extractor from the portable recording medium, and then reading and reproducing the selected program to be reproduced.

37. A recording medium playback method for reproducing the portable recording medium of claim 9, the method comprising the steps of:
extracting an available program from the portable recording medium; and
during pseudo-random playback guaranteeing number of playbacks, reproducing non-sequentially the extracted program in such a way that when the extracted program is reproduced a predetermined number of playbacks, number of playbacks based on occurrence frequency parameter information is guaranteed.

38. A recording medium playback method for reproducing the portable recording medium of claim 10, the method comprising the steps of:
extracting an available program from the portable recording medium; and
during pseudo-random playback guaranteeing number of playbacks, reproducing non-sequentially the extracted program in such a way that when the extracted program is reproduced a predetermined number of playbacks, number of playbacks based on occurrence frequency parameter information is guaranteed, and that a selection probability that a certain program is selected becomes a specified value based on the guaranteed number of playbacks.

39. A recording medium playback method for reproducing the portable recording medium of claim 11, the method comprising the steps of:
extracting an available program from the portable recording medium; and
during pseudo-random playback guaranteeing number of playbacks, reproducing non-sequentially the extracted program while changing a selection probability of each of the programs in such a way that:
when the extracted program is reproduced a predetermined number of playbacks, number of playbacks based on occurrence frequency parameter information is guaranteed; in a first program playback, a selection probability that any one of the programs is selected is a value based on the guaranteed number of playbacks; and thereafter until program playbacks of the guaranteed number of playbacks are finished, a probability of each of the programs becomes a value based on remaining number of playbacks of each of the programs that is obtained by subtracting a number of times that each of the programs has been actually reproduced from the guaranteed number of playbacks.

40. A recording medium playback method for reproducing the portable recording medium of claim 12, the method comprising the steps of:
during the non-sequential playback, extracting an available program from the portable recording medium in accordance with program selection condition information table read from the portable recording medium and the user-definable program selection condition information; and
during pseudo-random playback guaranteeing number of playbacks, reproducing non-sequentially the extracted program in such a way that when the extracted program is reproduced a predetermined number of playbacks, number of playbacks based on occurrence frequency parameter information is guaranteed.

41. A recording medium playback method for reproducing the portable recording medium of claim 13, the method comprising the steps of:
extracting an available program from the portable recording medium in accordance with a program selection condition information table read from the portable recording medium and information selected by use of the menu screen content data information; and
during pseudo-random playback guaranteeing number of playbacks, reproducing non-sequentially the extracted program in such a way that when the extracted program is reproduced a predetermined number of playbacks, number of playbacks based on occurrence frequency parameter information is guaranteed.

42. A recording medium playback method for reproducing the portable recording medium of claim 14, the method comprising the steps of:
holding present time information;
extracting an available program from the portable recording medium in accordance with an expiration date information table read from the portable recording medium and the present time information; and
during pseudo-random playback guaranteeing number of playbacks, reproducing non-sequentially the extracted program in such a way that when the extracted program is reproduced a predetermined number of playbacks, number of playbacks based on occurrence frequency parameter information is guaranteed.
